(19) United States
(12) Patent Application Publication
(10) Pub. No.: US 2026/0024251 A1
(43) Pub. Date: Jan. 22, 2026

(54) TRANSFORMING DIGITAL FRAMES USING RELATIONSHIPS BETWEEN THE DIGITAL FRAMES

(71) Applicant: Adobe Inc., San Jose, CA (US)

(72) Inventors: Seoungwug Oh, San Jose, CA (US); Suhwan Cho, Seoul (KR); Joon-Young Lee, San Jose, CA (US); Arghya Sur, Noida (IN); Anusree Sarkar, Faridabad (IN)

(73) Assignee: Adobe Inc., San Jose, CA (US)

(21) Appl. No.: 18/776,953

(22) Filed: Jul. 18, 2024

(51) Int. Cl. G06T 11/60; G06T 5/50; G06V 10/75

(52) U.S. Cl. CPC G06T 11/60; G06T 5/50; G06V 10/751; G06T 2207/20221

(57) ABSTRACT

Techniques for transforming digital frames using relationship between the digital frames are described. In an example, a computing device can receive a set of digital frames and a set of masks. A computing device can obtain relationships between digital frames of the set of digital frames based on respective displacements of attributes between sequential digital frames. A computing device can obtain one or more pixel values in a portion of at least one digital frame that is define by the mask using corresponding pixel values of other digital frames and the relationships. A computing device can transform (e.g., replace, update) the portion of the at least one digital frame using the one or more pixel values.

### BACKGROUND

Digital video editing by computing devices involves additional technical challenges that are not found in other types of digital content. Digital video, for instance, is configured as a sequence of digital frames that are usable to exhibit motion of objects between frames.

Accordingly, in order to edit a digital video the computing device is tasked with determining an optical flow to represent motion of pixels between frames of the digital video. However, conventional techniques used to determine optical flow often fail due to misalignment errors and therefore cause visual artifacts such as blurriness.

### SUMMARY

Techniques are described for transforming at least a portion of digital frames of a digital video by using pixel propagation techniques that maintain a detail of the portion of the digital frames. In one or more examples, the computing device warps an optical flow and respective digital frames of the optical flow once, which reduces conventional inaccuracies caused by repeated interpolation between pixels of different digital frames and inaccurate motion estimation when compared with conventional techniques that warp a digital frame multiple times.

A computing device, for instance, is configurable to determine values of pixels for a digital frame of the digital video using values of pixels from other digital frames of the digital video obtained by warping the digital frame and relationships between the digital frames of the digital video obtained by warping the optical flow. The computing device uses the values of the pixels to edit a portion of the digital frame and repeats the process for other digital frames of the digital video. These techniques enable detailed transformation of a portion of digital frames, such that the computing device maintains the detail of the portion of the digital frames and the portion of the digital frames does not appear blurry as caused by conventional techniques.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities, thus reference is made interchangeably to single or plural forms of the entities in the discussion.

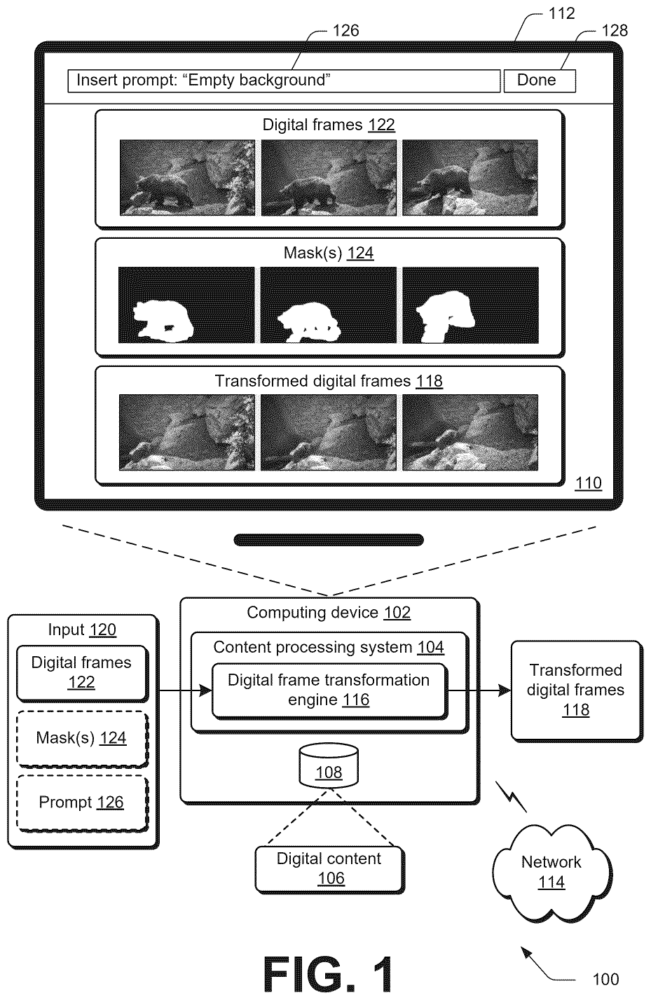

FIG. 1 is an illustration of a digital medium environment in an example implementation that is operable to employ techniques described herein for transforming digital frames using relationships between the digital frames.

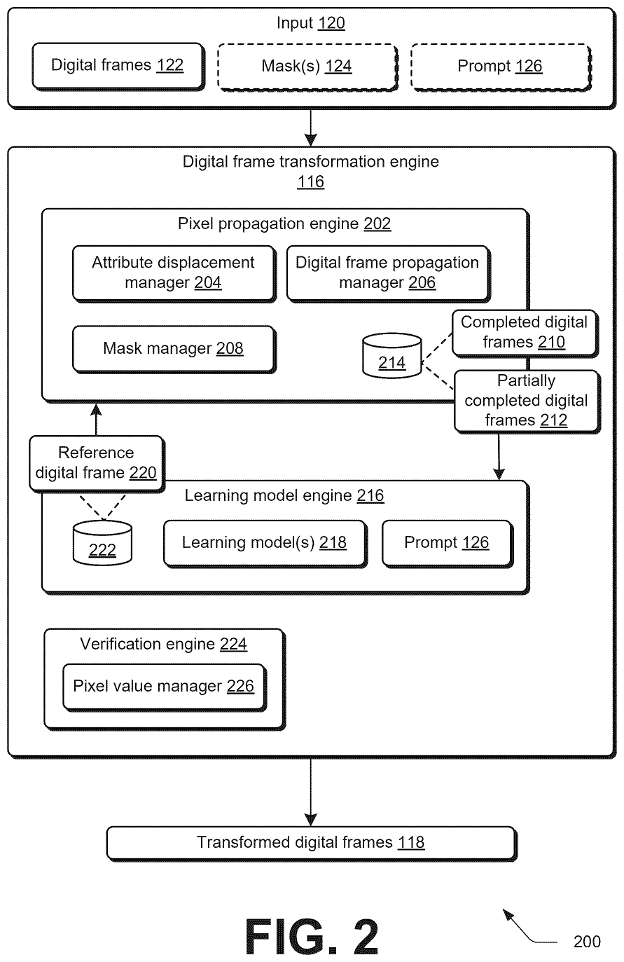

FIG. 2 depicts a system as an example implementation of a digital frame transformation engine that is operable to employ techniques described herein for transforming digital frames using relationships between the digital frames.

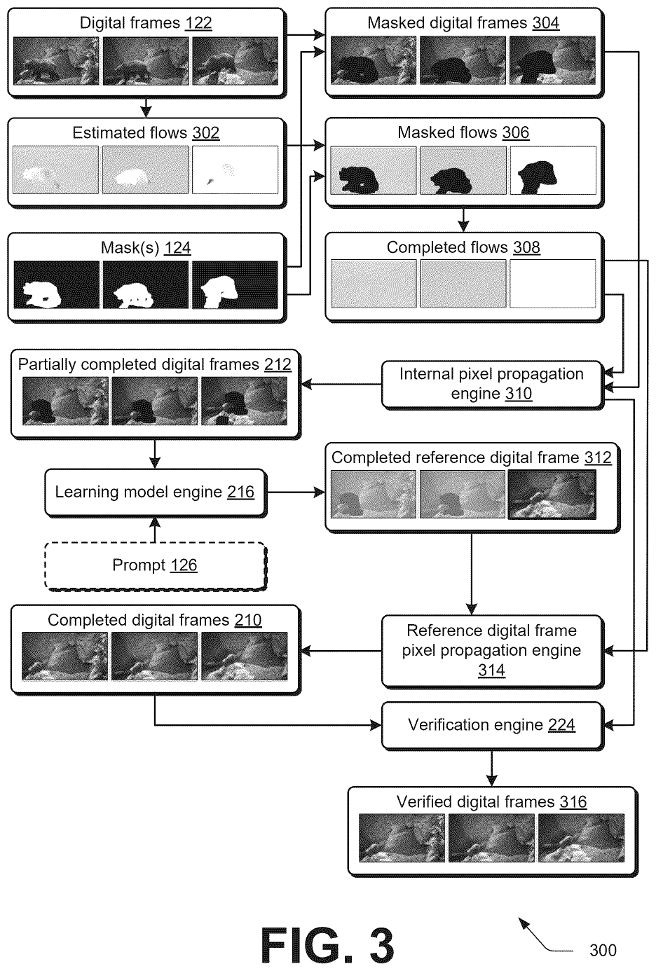

FIG. 3 depicts a system as an example implementation of a computing device that is operable to employ techniques described herein for generating verified digital frames by transforming digital frames using relationships between the digital frames.

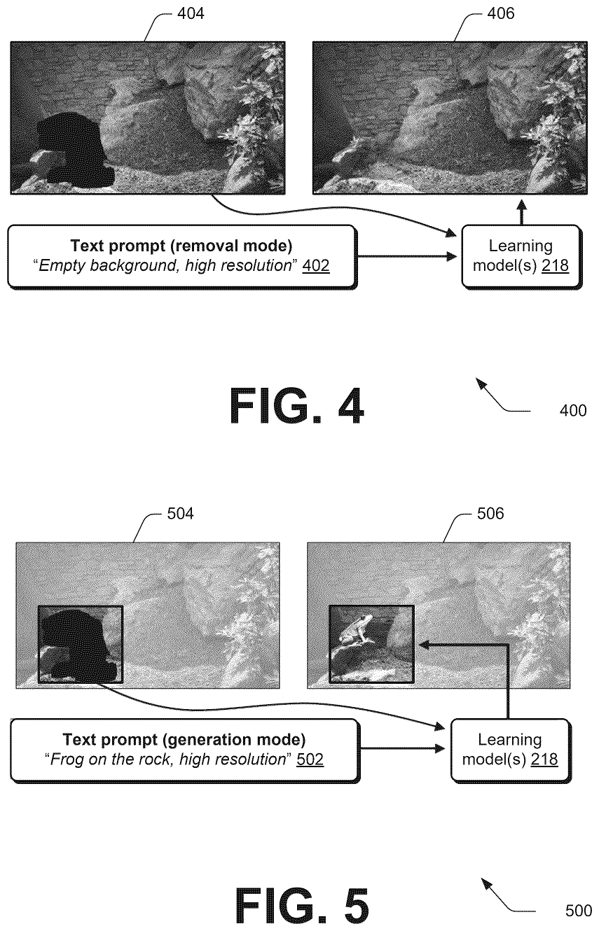

FIG. 4 depicts a visualization of transforming a digital frame by removing attributes based on a text prompt.

FIG. 5 depicts a visualization of transforming a digital frame by generating new attributes using based on a text prompt.

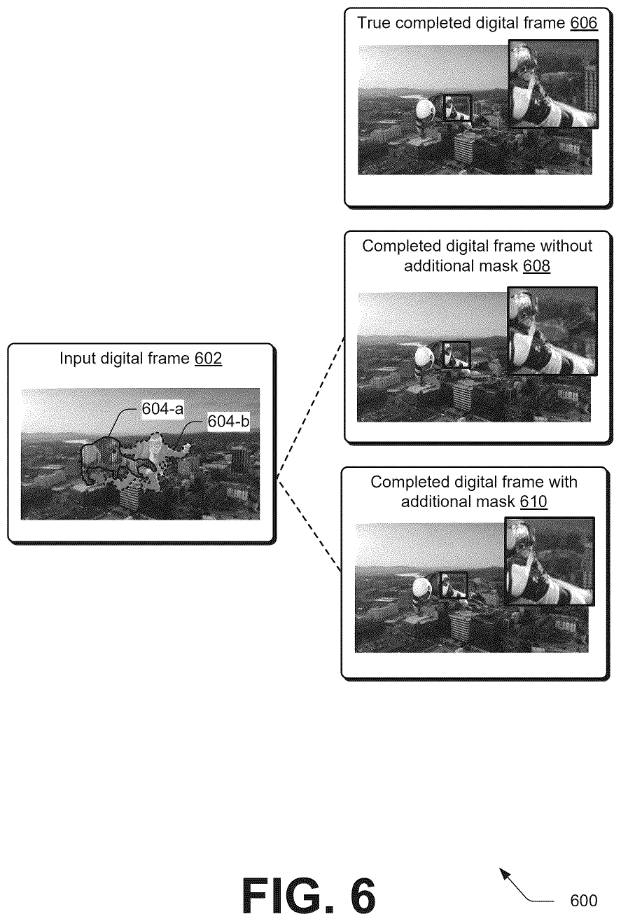

FIG. 6 depicts a visualization of transforming a digital frame using multiple masks.

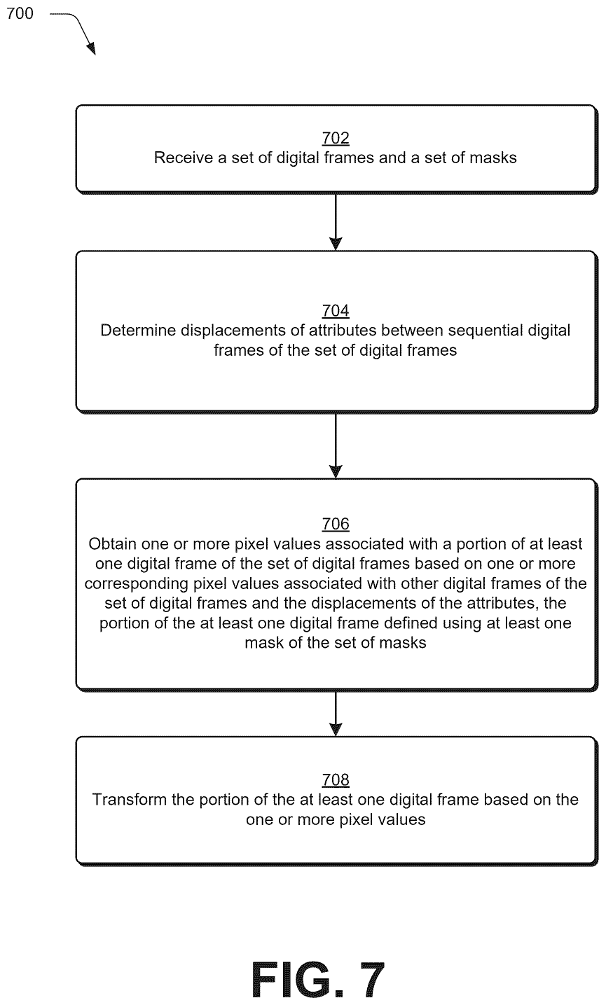

FIG. 7 is a flow diagram depicting an algorithm as a step-by-step procedure in an example implementation of the digital frame transformation engine, which is performable by a computing device to transform digital frames using relationships between the digital frames.

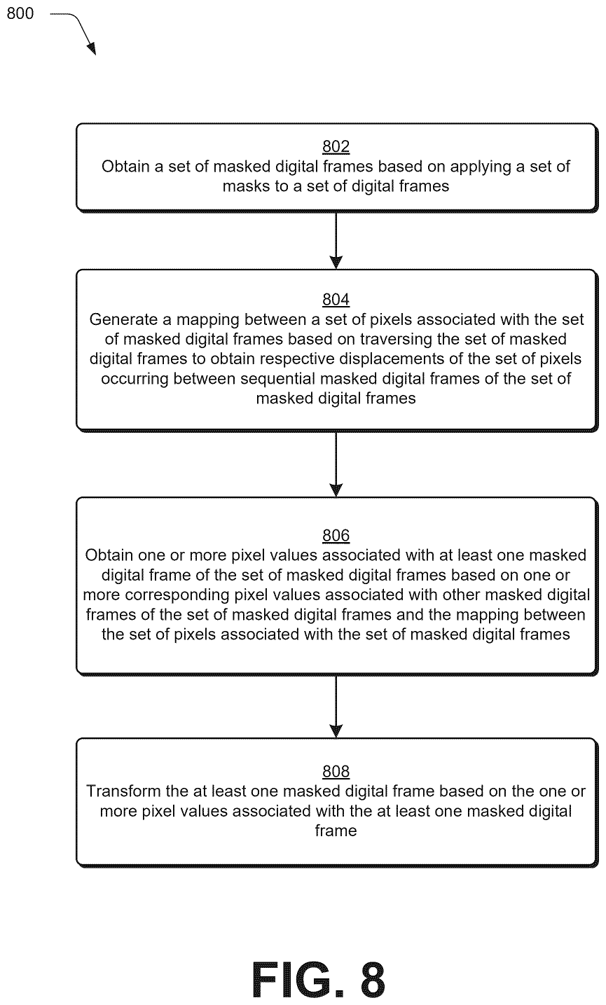

FIG. 8 is a flow diagram depicting an algorithm as a step-by-step procedure in an example implementation of the digital frame transformation engine, which is performable by a computing device to transform digital frames by generating a mapping between the digital frames.

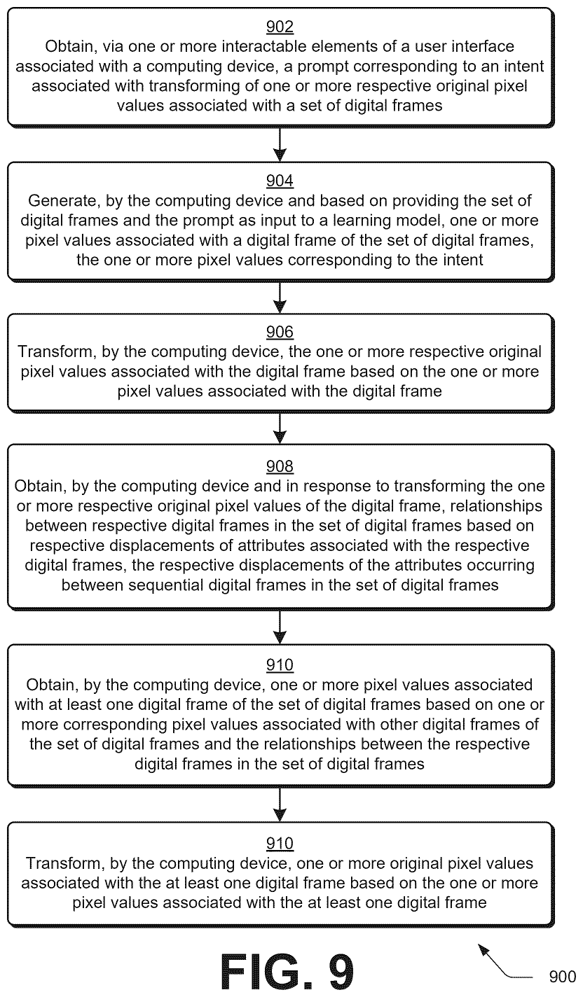

FIG. 9 is a flow diagram depicting an algorithm as a step-by-step procedure in an example implementation of the digital frame transformation engine, which is performable by a computing device to transform digital frames according to an intent of a prompt and by generating pixel values for transforming the digital frames that correspond to the intent.

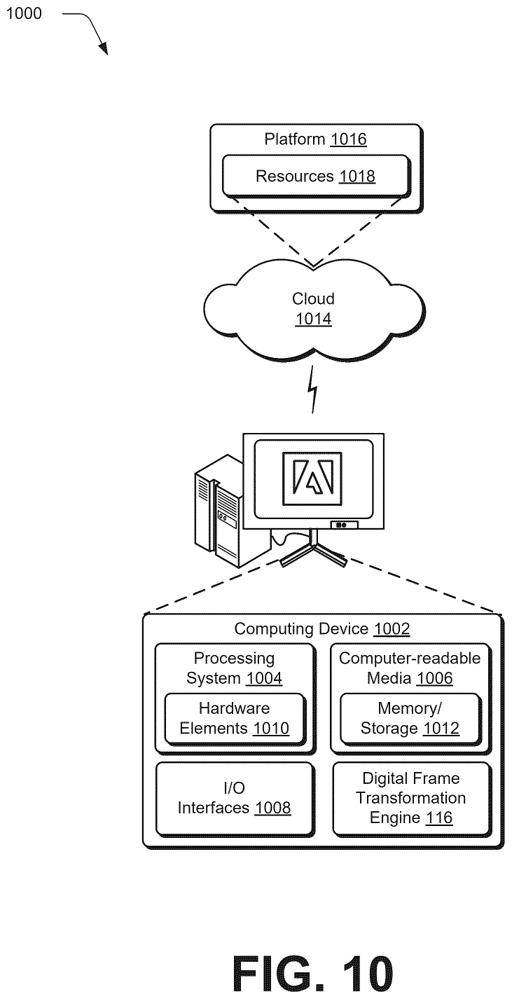

FIG. 10 illustrates an example system including various components of an example device that can be implemented as any type of computing device as described and/or utilized with reference to FIGS. 1 through 9 to implement examples of the techniques described herein.

### DETAILED DESCRIPTION

### Overview

Conventional techniques employed by computing devices to edit digital videos rely on per-pixel propagation, in which, the computing device analyzes a change in a location and value of individual pixels across respective digital frames to determine an optical flow. However, changes in a location or value of a pixel can occur at a sub-pixel level, e.g., there can be changes that occur in between pixels. Therefore, conventional techniques used to analyze changes at a pixel granularity can lead to misalignment errors due to inaccurate propagation of the pixel across the optical flow. The misalignment errors can cause portions of the edited digital video to appear blurry.

To address these and other technical challenges, techniques are described to reduce misalignment errors for per-pixel propagation techniques, while also maintaining a detail of the digital frames in an optical flow. To do so, a computing device is configured to warp optical flows (e.g., by using a grid warping operation) between successive digital frames to obtain a relationship between a source digital frame and a target digital frame. The relationship can be in the form of a mapping of respective digital frames between a source digital frame and a target digital frame to align the source digital frame to the target digital frame. The computing device, for instance, obtains a single flow field between a source digital frame and a target digital frame by warping the target digital frame using the source digital frame and by referencing the mapping of respective digital frames to align the source digital frame and the target digital frame. That is, the computing device can use the mapping to obtain values of pixels for a target digital frame using values of pixels from a source digital frame, where the target digital frame and the source digital frames may not be neighboring or nearby digital frames. The computing device warps a digital frame of the optical flow once, which maintains the detail of the digital frames when compared with conventional techniques for pixel propagation that include warping a digital frame multiple times. The computing device uses the calculated values of the pixels for the target digital frame to transform a portion of the target digital frame.

In some examples, the described pixel propagation techniques may not be sufficient to transform an entirety of a portion of a digital frame of a digital video. To address this, the computing device is configurable to implement a generative artificial intelligence (AI) model to generate pixel values for a portion of a digital frame that is yet to be transformed after the computing device applies the described pixel propagation techniques. A generative AI model is a type of algorithm designed to generate new data that resembles a dataset. Generative AI models are trained to detect underlying structure and patterns within the dataset to create new data that is similar to the dataset (e.g., rather than categorizing or labeling existing data). In some variations, a generative AI model is capable of generating new pixel values for attributes of a digital frame based on patterns learned from existing digital content. For example, the generative AI model can generate pixel values to use for transforming a portion of an attribute of a digital frame in an optical flow. The digital frame in the optical flow is referred to as a reference digital frame. The computing device can use the reference digital frame and the described pixel propagation techniques to propagate the generated pixel values to the other digital frames in the optical flow. By implementing the described pixel propagation techniques, as well as the generative AI model, the computing device can transform a digital video with a relatively high level of detail and accuracy when compared with conventional techniques.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Frame Transformation Environment

FIG. 1 is an illustration of a digital medium environment 100 in an example implementation that is operable to employ techniques described herein for transforming digital frames using relationships between the digital frames. The digital medium environment 100 includes a computing device 102, which is configurable in a variety of ways.

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low-resource device with limited memory and/or processing resources (e.g., mobile devices). Although the computing device 102 is shown as a single device, the computing device 102 is also representative of multiple different devices (e.g., a computing system), such as multiple servers utilized by a business to perform operations “over the cloud” as described in FIG. 8.

The computing device 102 is illustrated as including a content processing system 104. The content processing system 104 is implemented at least partially in hardware of the computing device 102 to process and transform digital content 106, which is illustrated as maintained in storage 108 of the computing device 102. Such processing includes creation of the digital content 106, modification of the digital content 106, and rendering of the digital content 106 in a user interface 110 for output (e.g., by a display device 112). Although illustrated as implemented locally at the computing device 102, functionality of the content processing system 104 is also configurable in whole or in part through functionality available via a network 114, such as part of a web service or “in the cloud.” For example, the content processing system 104 is configurable to be communicatively coupled with the computing device 102 via the network 114. One example of the networks 114 is the Internet, although the computing device 102 and the content processing system 104 can be communicatively coupled using one or more different connections or different networks (e.g., wireless networks) in various implementations.

In some examples, the digital content 106 includes any type of information and/or media that is created, stored, transmitted, and consumed in a digital format (e.g., that can be represented by 1s and 0s). Examples of the digital content 106 can include, but are not limited to, digital text, digital images, digital audio, digital videos, and/or interactive digital content. The digital text can include articles, documents, electronic books, emails, blog posts, and/or any other digital text. The digital images can include photographs, illustrations, graphics, charts, diagrams, and/or any other digital images. The digital audio can include music tracks, podcasts, audiobooks, sound effects, voice recordings, and/or any other digital audio. The digital videos can include movies, television shows, video logs, tutorials, animations, and/or any other digital videos. The interactive media content can include video games, applications (e.g., desktop applications, web-based applications, or mobile applications), augmented reality (AR) experiences, virtual reality (VR) experiences, and/or any other interactive digital content. Digital content 106 can be created, distributed, and consumed by one or more users through various digital platforms, such as websites, social media platforms, streaming services, online marketplaces, applications, and/or digital libraries.

The storage 108 can represent one or more databases and/or other types of storage capable of storing the digital content 106. Examples of the storage 108 include, but are not limited to, mass storage and virtual storage. For example, the storage 108 can be virtualized across multiple data centers and/or cloud-based storage devices. In some variations, the storage 108 can store one or more instances of digital content 106. For example, the storage 108 can include one or more digital videos. A digital video can include multiple digital frames that make up a video sequence. A digital frame is a single static digital image or digital picture within the video sequence. That is, a digital video includes a series (e.g., a time-series) of individual digital frames that are displayed in successive time intervals to create the illusion of motion within the digital frames.

A digital frame can include one or more pixels, where a pixel is the smallest controllable element of a digital image. The pixels can be arranged in a grid formation across an image, such that a pixel has a define location within the grid. Respective pixels are defined by unique color values. When combined together in varying intensities and arrangements, pixels can be displayed as a digital image with a continuous tone.

An example of functionality incorporated by the content processing system 104 to process the digital content 106 is illustrated as a digital frame transformation engine 116. The digital frame transformation engine 116 is configured to generate one or more transformed digital frames 118 based on an input 120 that includes digital frames 122 (e.g., a sequence of digital frames), one or more masks 124, and/or a prompt 126. For example, the digital frame transformation engine 116 can be implemented at least partially in hardware and/or software at the computing device 102 or at a device remote from the computing device 102. For example, the digital frame transformation engine 116 can include instructions, which when executed by a hardware component (e.g., a processor), cause the computing device 102 to transform the digital frames 122 into the transformed digital frames 118.

In the illustrated example, the digital frame transformation engine 116 receives the digital frames 122, which depict a sequence or series (e.g., a time-series) of images of a bear walking across a nature background scene. The digital frames 122 can be at least part of a digital video content obtained by the computing device 102. For example, the computing device 102 can receive the digital frames 122 from another computing device via the network 114, can receive user input indicating the digital frames 122 (e.g., a user can upload the digital frames 122), and/or can receive the digital frames 122 from a component of the computing device 102 (e.g., a camera component of the computing device 102 can collect the digital frames 122 and send the digital frames 122 to the content processing system 104), among other examples. The user interface 110 can display the digital frames 122, such that when displayed in sequence, the digital frames 122 cause the appearance of motion of one or more attributes of the digital frames 122. The attributes of the digital frames 122 can include objects in the digital frames 122, surfaces in the digital frames 122, edges (e.g., of a visual scene) in the digital frames 122, and/or other features. For example, the attributes of the digital frames 122 can include a bear, the edges of the rocks in the background, the edges of the shadows, the vegetation, and/or any changes in color or shade that follow a pattern.

In some examples, the apparent motion of attributes in the digital frames 122 can be referred to as optical flow. The optical flow represents a displacement of attributes between consecutive digital frames in a sequence of the digital frames 122. That is, optical flow describes how pixels in a digital frame 122 move from a digital frame 122 to a next (e.g., subsequent) digital frame 122.

In some examples, the computing device 102 can obtain the optical flow of a sequence of the digital frames 122 using one or more techniques. For example, the computing device 102 can implement differential techniques to calculate the optical flow by analyzing a change in pixel intensity between neighboring digital frames. Additionally, or alternatively, the computing device 102 can implement correlation-based techniques to calculate the optical flow by determining a match between patches or regions in different digital frames 122. Additionally, or alternatively, the computing device 102 can implement variational techniques to calculate the optical flow by calculating a flow field that minimizes an energy function. A flow field includes a vector field where respective pixels in a digital frame 122 are represented by a displacement vector that indicates the direction and magnitude of motion between consecutive digital frames 122.

In some examples, the digital frame transformation engine 116 can receive one or more masks 124, such as via user input and/or from another device. The masks can include a layer that, when used in conjunction with the digital frame 122, defines areas for which the digital frame 122 is to be edited and/or modified. In some other examples, the digital frame transformation engine 116 can determine the masks 124 from a prompt 126. For example, if the prompt 126 indicates for the digital frame transformation engine 116 to generate an “Empty background,” then the digital frame transformation engine 116 can analyze the digital frames 122 and generate the masks 124 to provide for the removal of any foreground attributes from the digital frames 122. If the digital frames 122 include a bear in the foreground, then the masks 124 (e.g., generated or provided) can include an outline of the bear to indicate that the bear is to be modified and/or edited in the digital frames 122.

In some examples, the user interface 110 can include one or more interactable elements to provide for a user to indicate the prompt 126. For example, the user interface 110 can include an interactable element that provides for a text input that includes the prompt 126. The user interface 110 can include a button 128 and/or other interactable element that provides for the submission of the prompt 126. The digital frame transformation engine 116 can provide the prompt 126 and the digital frames 122 as input to one or more learning models (e.g., one or more generative AI models) to generate the masks. The learning models can perform language processing (e.g., to contextualize the text in the prompt 126) and/or video processing (e.g., using object detection algorithms to identify and localize objects or attributes within digital frames 122) to determine an intent of the prompt 126 and to generate corresponding masks 124.

In some examples, the digital frame transformation engine 116 can implement pixel propagation techniques to obtain the transformed digital frames 118. If the pixel propagation techniques are not sufficient to transform the digital frames 122, then the digital frame transformation engine 116 can use learning models to generate one or more updated pixels for a digital frame 122. The updated pixels for the digital frame 122 can then be propagated to other digital frames 122 in the sequence of the digital frames 122.

In some variations, to transform the digital frames 122 into the transformed digital frame 118, the digital frame transformation engine 116 can edit the digital frames 122. For example, the digital frame transformation engine 116 can perform video inpainting, which includes removing an area or objects (e.g., removing one or more attributes) from an existing digital frame 122 and filling the removed area or object with new contents. To maintain original video contents and temporal consistency, the digital frame transformation engine 116 propagates observable contents across the digital frames 122 while concurrently generating new contents (e.g., non-observable contents) that do not appear in the original digital frames 122.

Conventional techniques include coupling the propagation and generation through end-to-end training of learning models. For example, conventionally a learning model (e.g., generative AI model) is trained based on three-dimensional (3D) convolutions using adversarial loss. A 3D convolution applies 3D filters (e.g., kernels) across spatial and temporal dimensions of digital video content. The learning model can use the 3D convolution to capture spatial and temporal patterns concurrently. Adversarial loss includes training a discriminator leaning model to distinguish between real and generated data, while concurrently training a generator leaning model to produce data that is indistinguishable from real data according to the discriminator leaning model. In the context of 3D convolutions, adversarial loss can be used to train a generator leaning model to produce realistic sequences of digital frames 122 while also leveraging the feedback from the discriminator learning model to improve the quality of generated digital video content. However, learning models trained based on 3D convolutions can fail to maintain temporal consistency due to a limited temporal window size.

To address the failure to maintain the temporal consistency, conventional techniques can include temporal relation reasoning through attention mechanism or Homography transformation. For example, a computing device 102 can use attention mechanisms to selectively focus on relevant regions of an image or feature map, which provides for a learning model to identify objects or features without distractions. Homography transformation is a geometric transformation that maps points from one image to another image. However, these conventional techniques fail to generate plausible contents when there is no reference available in digital video content. That is, coupling the propagation and generation leads to failure to maintain temporal consistency and/or failure to generate plausible contents due to ambiguity between generation and propagation.

The computing device 102 can implement a decoupled framework using a flow-based method. In a decoupled framework, the computing device 102 can compute optical flows to propagate the contents between digital frames 122 and can use a separate learning model to generate non-observable contents. However, conventional techniques for pixel propagation cause delays in processing the digital frames 122 and/or lead to relatively low-quality digital video content, e.g., below a threshold quality, blurry digital video content, and so on. For example, conventional techniques for pixel propagation can include a per-pixel flow tracing algorithm, which leads to spatial misalignment when transforming the digital frames 122 due to a loss of sub-pixel accuracy. Other conventional techniques use a recurrent pixel warping algorithm, which can preserve sub-pixel accuracy, but causes resampling artifacts due to the repeated color sampling. The repetitive resampling causes loss of details when transforming the digital frames 122. The loss of sub-pixel accuracy and the resampling of artifacts can degrade the quality or resolution in the digital video content, leading to blurry or inaccurate digital video content.

In some examples, the computing device 102 can implement a decoupled architecture for pixel propagation and generation that maintains a sufficient quality (e.g., greater than a threshold resolution, greater than a threshold accuracy, or other quality metrics), when compared with conventional techniques. For example, the computing device 102 can implement a pixel propagation technique by combining flow tracing and grid warping to prevent, or reduce, resampling artifacts while keeping sub-pixel accuracy. The digital frame transformation engine 116 can warp optical flows instead of color values and can pull the color value from the matching pixel in a single warp of the digital frames 122, which is described in further detail with respect to FIG. 3. In some cases, the digital frame transformation engine 116 can implement a propagation verification method that detects an area in which a propagation does not satisfy a threshold reliability value, which is described in further detail with respect to FIG. 2. In some examples, the digital frame transformation engine 116 can use multiple masks to reduce, or prevent, color bleeding artifacts from inaccurate optical flows, which is described in further detail with respect to FIG. 6.

The digital frame transformation engine 116 can use one or more learning models to generate content for the digital frames 122 that is not sufficiently transformed by the pixel propagation techniques. For example, the digital frame transformation engine 116 can perform stable diffusion using a latent diffusion model, which is described in further detail with respect to FIG. 2. A latent diffusion model can provide for improved digital video content generation quality and can provide for texture replacement based on text guidance (e.g., from the prompt 126).

The digital frame transformation engine 116 can generate the transformed digital frames 118 using the improved pixel propagation techniques and the propagation verification method that detects possible errors during the pixel propagation. The digital frame transformation engine 116 incorporates one or more learning models (e.g., a generative AI model) into the decoupled framework for high-fidelity and controllable content generation. Thus, the digital frame transformation engine 116 can transform digital frames with a relatively high resolution (e.g., greater than a threshold resolution), while maintaining high generation quality. The techniques described herein further overcome limitations of conventional techniques that degrade a quality of digital video content and are computationally expensive or slow. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Transformation of Digital Frames

FIG. 2 depicts a system 200 as an example implementation of a digital frame transformation engine that is operable to employ techniques described herein for transforming digital frames using relationships between the digital frames. In some examples, the digital frame transformation engine 116, the input 120, the digital frames 122, the masks 124, the prompt 126, and the transformed digital frames 118 may be examples of the corresponding features as described with reference to FIG. 1. In some cases, the digital frame transformation engine 116 is operable to implement a decoupled framework for pixel propagation and generation to edit or modify one or more digital frames 122.

The digital frame transformation engine 116 can obtain an input 120, which can include one or more digital frames 122, one or more masks 124, and/or a prompt 126. The digital frame transformation engine 116 can use the input 120 to generate the transformed digital frames 118. In some variations, the digital frame transformation engine 116 can transform the digital frames 122 by performing inpainting, which includes removing a portion from the respective digital frames 122 and replacing the removed portion with new content. The new content can be obtained via pixel propagation and/or through generation. Additionally, or alternatively, the digital frame transformation engine 116 can transform the digital frames 122 by applying an effect to at least a portion of the respective digital frames 122, where the effect changes a value of one or more pixels of the portion of the respective digital frames 122. For example, the effect can include changing a color, tone, intensity, etc. of the value of the one or more pixels.

In some examples, the digital frame transformation engine 116 can provide the input 120 to a pixel propagation engine 202. The pixel propagation engine 202 is operable to replace, update, and/or modify missing or corrupted pixels in the digital frames 122 by propagating information from other digital frames 122. The pixel propagation engine 202 can implement an attribute displacement manager 204, a digital frame propagation manager 206, and/or a mask manager 208 to calculate new or updated values for pixels in at least a portion of the digital frames 122. For example, the mask manager 208 can determine that the input 120 includes one or more masks 124. If the input 120 does not include the one or more masks 124, then the mask manager 208 can implement one or more learning models to generate the one or more masks 124 from the digital frames 122 and the prompt 126, as described with reference to FIG. 1.

The mask manager 208 can identify one or more portions of the digital frames that are to be transformed. For example, the mask can include an outline, or other indication, of a region or portion of the digital frames 122 to be transformed. Respective digital frames 122 in a sequence of digital frames received as the input 120 can have corresponding masks 124. Additionally, or alternatively, there can be a single mask 124 for a reference digital frame 122, and the mask manager 208 can propagate the mask to other digital frames 122 using learning models, or other image processing techniques, to identify the region or portion indicated by the mask 124 in the other digital frames 122.

The attribute displacement manager 204 can determine displacements of pixels within one or more regions or portions indicated by the mask between respective digital frames 122 in a sequence of the digital frames 122. That is, the attribute displacement manager 204 can warp the optical flows in the sequence of the digital frames 122 to determine mappings between respective digital frames 122. The mapping can include an indication of a displacement (e.g., movement) of a pixel across sequential digital frames 122, such that movement of the pixels between the respective digital frames 122 is represented by the mapping. To warp the optical flow, the attribute displacement manager 204 can use grid warping techniques. Grid warping, also known as grid deformation or mesh warping, is a technique used to spatially analyze changes between digital frames 122 using a grid overlay. An initial grid or mesh is overlaid onto an initial digital frame in the sequence of the digital frames 122, which can be referred to as a source digital frame. The grid includes horizontal and vertical lines that divide the digital frame 122 into smaller regions, which can be squares or rectangles. Control points are defined at the intersections of the grid lines. The control points serve as anchor points that the attribute displacement manager 204 can move to specify a deformation of the digital frame 122. The attribute displacement manager 204 maps pixels in the digital frame 122 to a corresponding location in the deformed grid. Thus, the attribute displacement manager 204 can obtain vectors that indicate a direction and magnitude of a displacement for respective pixels in a region and/or portion of respective digital frames 122 relative to the source digital frame.

The digital frame propagation manager 206 can transform one or more pixels in respective regions and/or portions of digital frames 122 in a sequence by transforming a target digital frame in the sequence of the digital frames 122 (e.g., warping the target digital frame) using a mapping of the digital frames 122 to the source digital frame. The source digital frame can be an initial digital frame in the sequence and the target digital frame can be a final digital frame in the sequence. In some examples, the pixel propagation engine 202 can store digital frames 122 that have been completely transformed by the pixel propagation engine 202 (e.g., completed digital frames 210) and/or digital frames 122 that have been partially transformed by the pixel propagation engine 202 (e.g., partially completed digital frames 212). For example, the pixel propagation engine 202 can store the completed digital frames 210 and the partially completed digital frames 212 in storage 214, which can be an example of the storage 108 as described with reference to FIG. 1.

In some examples, the pixel propagation engine 202 may be unable to transform an entire region or portion of the digital frames 122 indicated by the masks 124. Thus, the pixel propagation engine 202 can send the partially completed digital frames 212 to a learning model engine 216. The learning model engine 216 can include one or more learning models 218 and can access the prompt 126. The learning model engine 216 can provide the prompt 126 and the partially completed digital frames 212 to the learning models 218. The learning models can provide a reference digital frame 220 as output. The learning model engine 216 can store the reference digital frame 220 at storage 222, which may be an example of the storage 108 as described with reference to FIG. 1.

As used herein, a learning model 218 includes a computer representation that is tunable (e.g., through training and retraining) based on inputs without being actively programmed by a user to approximate unknown functions, automatically and without user intervention. For example, a learning model 218 uses algorithms to learn from and make predictions on known data by analyzing training data to learn and relearn to generate outputs that reflect patterns and attributes of the training data. Examples of learning models 218 include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

The learning models 218 can be examples of generative AI models. A generative AI model is an algorithm designed to generate new data that resembles a given dataset. A generative AI model models learns one or more underlying patterns and structures of training data and can then generate new samples that are similar to original data. For example, the learning models 218 can generate new content to replace a region or portion of the digital frames 122 in a sequence (e.g., a remaining portion to be transformed of the partially completed digital frames 212) by providing the partially completed digital frames 212 and, optionally, the prompt 126 to the learning models 218.

In some examples, the learning models 218 are trained by the digital frame transformation engine 116 and/or by another device or component of a device that then provides the trained learning models to the digital frame transformation engine 116. The learning models 218 are trained using images of a large-scale video object segmentation dataset (e.g., greater than a threshold numerical quantity of digital videos). Digital frames (e.g., images) are randomly sampled and masked, where original digital frames are used as ground truth, and the masked digital frames are used as input to train the learning models 218, along with binary masks. The digital frames used to train the learning models 218 can include random region masking (e.g., as in general inpainting tasks) and/or random object masking to simulate object removal scenarios. In some examples, the training can include minimizing a loss function, such as a mean absolute error (MAE) or L1 loss function and/or an adversarial loss function. The device or component training the learning models 218 can implement adaptive moment estimation (Adam) to update the parameters (e.g., weights and biases) of the learning models 218 during training based on the gradients of the loss function with respect to those parameters. In some examples, one or more parameters for Adam, referred to as hyperparameters, are tuned or updated based on the dataset, among other factors, and can include a learning rate (e.g., a learning rate of 1e-4 without learning rate decay) and decay rates for the learning rate, among others.

The learning models 218 can include one or more diffusion models, among other types of learning models. Diffusion models are a class of generative AI models that operate by iteratively diffusing noise through a given data distribution. In a diffusion step, noise is added to a current sample, and the resulting noisy sample is gradually transformed to resemble an original sample using a learned diffusion process. By performing multiple diffusion steps, the learning model 218 learns to generate samples that match a target distribution within a threshold value, such as for regions or portions of digital frames 122. The diffusion models can perform stable diffusion and/or latent diffusion.

In stable diffusion, the diffusion process is controlled by a parameter that modulates the rate at which noise is added to the samples, which improves a stability and convergence of the diffusion process. In latent diffusion, samples are generated by first sampling from a prior distribution in a latent space (e.g., a dimensional space that represents learned features or representations of data captured by a learning model 218) and then applying a diffusion process to transform the latent samples into data samples. By operating in the latent space, a learning model 218 can capture complex dependencies in the data distribution more efficiently and generate higher-quality samples with fewer diffusion steps.

In some examples, the learning model engine 216 can evaluate a performance of one or more trained learning models 218. For example, the learning model engine 216 can provide testing data as input to a trained learning model 218 that includes a sequence of the digital frames 122 with foreground attributes that are blended with background attributes based on an alpha matte. The alpha matte specifies the opacity of pixels in the foreground of the digital frames 122, with higher values indicating greater opacity (e.g., fully visible) and lower values indicating greater transparency (e.g., fully transparent). That is, the alpha matte determines which attributes of the foreground of the digital frames 122 are visible, which attributes of the foreground of the digital frames 122 are semi-transparent, and which attributes of the foreground of the digital frames 122 are completely transparent.

Using testing data that includes digital frames 122 with foreground attributes that are blended with background attributes based on an alpha matte simulate realistic video editing scenarios, while providing the ground truth for attribute modification (e.g., updating or removal). Additionally, or alternatively, the learning model engine 216 can provide testing data as input to a trained learning model 218 that includes digital frames 122 with relatively large (e.g., greater than a threshold numerical quantity of pixels) that are to be transformed (e.g., are missing or corrupted). Additionally, or alternatively, the learning model engine 216 can provide testing data as input to a trained learning model 218 that includes digital frames 122 where the target attribute to be removed interacts with another attribute.

If a performance of the learning models 218 during testing does not satisfy a performance threshold (e.g., an accuracy threshold value, a precision threshold value, among other performance metric threshold of the learning models 218), then the learning model engine 216 can continue to provide additional training data to the learning models 218 to further fine-tine and/or retrain the learning models 218. Training a learning model 218, fine-tuning a learning model 218, and/or retraining a learning model 218 can include iterating over a training dataset multiple times and updating one or more parameters of the learning model 218 (e.g., weights, biases, and/or activation function parameters, among other parameters) to minimize a loss function that quantifies the difference between the model predictions and the true labels. Once the performance of the learning models 218 satisfies one or more threshold performance values, then the learning model engine 216 can deploy, execute, or implement the learning models 218 to generate new content (e.g., pixel values) for one or more digital frames 122.

For example, the learning models 218 can process the prompt 126 to determine an intent of the transformation of the digital frames 122, which is described in further detail with respect to FIGS. 4 and 5. The learning models 218 can generate new pixels to update and/or replace existing pixels in a digital frame 122 according to the intent of the transformation (e.g., for inpainting and/or to apply effects to the digital frames 122). The learning model engine 216 can use the new pixels to update and/or replace the existing pixels in the digital frame 122 to generate (e.g., obtain, create) a reference digital frame 220. The learning model engine 216 can provide the reference digital frame 220 to the pixel propagation engine 202, and the pixel propagation engine can propagate the updated and/or replaced pixels to other digital frames 122 in the sequence (e.g., using the attribute displacement manager 204, the digital frame propagation manager 206, and the mask manager 208 to perform the described pixel propagation techniques). Once the updated and/or replaced pixels are propagated, the pixel propagation engine 202 can store the completed digital frames 210.

The digital frame transformation engine 116 can include a verification engine 224 to confirm an accuracy of one or more pixel values in the completed digital frames 210. For example, the verification engine 224 can detect potential errors in pixel values by evaluating the reliability of a propagation of the pixel. The pixel propagation engine 202 uses the attribute displacement manager 204 and the digital frame propagation manager 206 to propagate pixels by mapping the pixels from a source digital frame to a target digital frame, or vice-versa, using an optical flow of the digital frames 122. One or more vectors that indicate a direction and magnitude of a displacement for respective pixels in a region and/or portion of respective digital frames 122 relative to the source digital frame can be inaccurate (e.g., can include differences in the value of the direction and/or magnitude).

A pixel value manager 226 of the verification engine 224 can compare pixel values obtained by the pixel propagation engine 202 by traversing the sequence of the digital frames 122 in a direction (e.g., from the source digital frame to the target digital frame) to pixel values obtained by the pixel propagation engine 202 by traversing the sequence of the digital frames 122 in a different direction (e.g., from the target digital frame to the source digital frame). If the compared value (e.g., a difference between the pixel values) exceeds a threshold value, then the pixel value manager 226 can flag the pixel as having a value outside of a define threshold accuracy. If the compared value is less than the threshold value, then the pixel value manager can confirm that the value of the pixel is within the defined threshold accuracy.

The learning model engine 216 can implement one or more learning models 218 (e.g., the same learning models 218 used to generate the reference digital frame 220 or different learning models 218) to generate new pixel values for the pixels that are flagged by the verification engine 224. Once the accuracy of the pixel values in the digital frames 122 is verified, the digital frame transformation engine 116 outputs the transformed digital frames 118.

FIG. 3 depicts a system 300 as an example implementation of a computing device that is operable to employ techniques described herein for generating verified digital frames by transforming digital frames using relationships between the digital frames. The computing device can implement aspects of, or can be implemented by, a computing device 102 as described with reference to FIG. 1.

In some examples, the computing device can use one or more input digital frames 122 (e.g., input images) and one or more masks 124 (e.g., input binary masks) for inpainting the input digital frames 122 and/or to update one or more pixels of the input digital frames 122 to apply effects (e.g., effects to enhance or alter the visual appearance of the input digital frames 122, create elements, or simulate an environment) to the input digital frames 122. For example, the computing device can remove (e.g., erase, change pixel values to a null value or 0 value) the masked regions in images and fill (e.g., replace, change the pixel values to new pixel values) the removed regions with new contents or attributes. The process can include internal pixel propagation to complete a removed area with the known pixels in a sequence of digital frames (e.g., a digital video). Additionally, or alternatively, the process can include reference generation to generate reference contents (e.g., that satisfy a threshold quality value) using one or more learning models. The computing device can implement reference propagation to distribute the generated pixels to the remaining digital frames in the sequence. The computing device can perform per-frame completion to complete a remaining missing region or portion of the digital frames.

In some examples, the computing device can receive input digital frames 122 and one or more masks 124. The input digital frames 122 can include one or more original digital frames, such as a sequence of digital frames, and can be examples of the digital frames 122 as described with reference to FIGS. 1 and 2. The computing device can receive an indication of the masks 124 and/or can generate the masks 124, where the masks 124 can be examples of the masks 124 as described with reference to FIGS. 1 and 2.

The computing device can generate one or more estimated flows 302 from the input digital frames 122. The estimated flows 302 can include optical flows that define the motion of one or more attributes in the input digital frames 122. For example, the optical flow can include displacement vectors for respective pixels in the input digital frames 122. The displacement vectors can indicate the direction and magnitude of the motion of the respective pixels, such that the input digital frames 122 can be represented by vector fields, as indicated by the shading in the estimated flows 302.

The computing device can use the masks 124 and the input digital frames 122 to generate masked digital frames 304. For example, the computing device can overlay the masks 124 over the input digital frames 122 to determine a portion or region of the input digital frames 122 to modify and/or replace. The computing device can mask and/or remove that region or portion of the input digital frames 122.

The computing device can use the masks 124 and the estimated flows 302 to generate masked flows 306. For example, the computing device can overlay the masks 124 over the estimated flows 302 to generate the masked flows 306. The computing device can mask and/or remove that region or portion of the estimated flows 302 to generate the completed flows 308.

For example, the computing device obtains the estimated flows 302 by calculating the optical flows of respective input digital frames 122 using recurrent all-pairs field transforms (RAFT) for optical flow. RAFT is a flow estimation method that uses a recurrent neural network (RNN) architecture to predict dense correspondences between pixels in consecutive digital frames of a sequence of digital frames. The computing device can process the estimated flows 302 to a format that the computing device can use to propagate the known pixels across the input digital frames 122. For example, the estimated flows 302 include information about the attribute that the computing device is to remove (e.g., the bear). The computing device removes the flows (e.g., vectors that define the pixel displacement) in the masked region or portion of estimated flows 302 to create the masked flows 306. The computing device can generate the completed flows 308 by replacing the removed flows with new vectors.

The computing device can use a recurrent protocol to obtain the completed flows (e.g., f_{i→j}, where i and j are adjacent digital frames in a digital video). The computing device can implement recurrent grid warping for pixel propagation to trace the optical flow with a sub-pixel accuracy. The computing device can sequentially chain the optical flows according to Equation 1:

$${f}_{i \to j} = \{ \begin{matrix}{f}_{i \to j - 1} + w ( {f}_{j - 1 \to j} , {f}_{i \to j - 1} ) , i < j \\ {f}_{i \to j + 1} + w ( {f}_{j + 1 \to j} , {f}_{i \to j + 1} ) , i < j ’\end{matrix} \qquad ( 1 )$$

where w(A, B) is a grid warping operation that warps A using flow B, and i and j are two arbitrary digital frames in a digital video. Subsequently, the computing device can establish a global correspondence map that defines relationships between respective digital frames in a sequence of digital frames. The computing device can use the relationships between respective digital frames in a sequence of digital frames to align any source digital frame in the sequence of digital frames to a target digital frame in the sequence of digital frames. For example, the computing device can use the global correspondence map to pull (e.g., obtain, use) the pixel values from source digital frames to fill (e.g., replace, update) corresponding pixel values of the target digital frames.

Thus, the described pixel propagation techniques warp optical flows (e.g., vector maps of digital frames), while conventional techniques warp pixel color values. The recurrent pixel warping accumulates propagation errors over a sequence of digital frames, which creates resampling artifacts and leads to decreased quality (e.g., resolution, accuracy) of the digital frames and a blurry texture. The optical flows have more consistent values (e.g., are smoother), thus the optical flows are more robust to the resampling artifacts than pixel color values. In addition to reducing the resampling artifacts by flow tracing, the described propagation techniques using optical flow increase a precision (e.g., when compared with pixel-wise flow tracing), as the described propagation techniques trace the flow at a sub-pixel precision. Furthermore, the described propagation techniques use fewer computational resources, including processing and memory resources, when compared with conventional techniques (e.g., as warping optical flows results in fewer warping operations than conventional techniques that perform pixel-wise flow tracing), which provides for the computing device to transform relatively high-resolution digital frames (e.g., greater than a threshold resolution) within a threshold time period.

The computing device can provide the completed flows 308 and the masked digital frames 304 to the internal pixel propagation engine 310 to generate partially completed digital frames 212. The internal pixel propagation engine 310 can be an example of, or can implement aspects of, the pixel propagation engine 202 as described with reference to FIG. 2. In some examples, the internal pixel propagation engine 310 can provide the partially completed digital frames 212 to a verification engine 224 to verify that the pixels are propagated correctly, as described with reference to FIG. 2. The verification engine 224 can be an example of, or can implement aspects of, the verification engine 224 as described with reference to FIG. 2.

In some examples, a missing or removed area (e.g., region, portion) of a digital frame in the masked digital frames 304 can be partially completed (e.g., updated, modified, filled) by propagating known pixels from other digital frames in the masked digital frames 304. The known pixels are propagated to the other digital frames using the mapping of relationships between digital frames obtained from the predicted optical flows (e.g., the completed flows 308).

For example, the computing device can obtain known pixels of the source digital frames to fill the missing area in the target digital frame by performing two sequential passes starting from the target digital frame in both the forward and backward directions to obtain the relationship between the target digital frame and the other digital frames in the sequence of digital frames. That is, the computing device can use the digital frames in a sequence of digital frames other than the target digital frame to obtain the relationship between the target digital frame and the other digital frames in the sequence of digital frames. A forward direction can include a direction from the target digital frame to source digital frames in the future, while a backward direction can include a direction from a source digital frame in the future to the target digital frame. The computing device assigns a greater priority to pixel color values from digital frames within a threshold numerical quantity of digital frames from the target digital frame. Therefore, the computing device collects respective pixel color values for a missing portion or region of the target digital frame for the forward direction and the backward direction. In some examples, although the computing device loops through different source digital frames, the computing device pulls the color values for respective pixel in a one-shot manner (e.g., without a repeated sampling process).

Once the computing device obtains the color value of the pixel by obtaining the relationships between the source digital frames and the target digital frame in both the forward direction and the backward direction, the computing device uses a verification engine 224 to perform a verification of the color values. For example, the verification engine 224 can determine a difference value as a distance between two three-channel color values that are normalized from 0 to 1. If the pulled color values from both directions are similar (e.g., the difference is less than a threshold value, less than 1), then the verification engine 224 allocates the average value to the target pixel location. If the propagated values are not similar (e.g., the difference is greater than a threshold value, greater than 1), then the verification engine 224 flags the target pixels as unreliable pixels, which invalidates the pixel propagation.

In some examples, the internal pixel propagation can be defined by an algorithm. The masked images X, given masks M, and completed flows f are provided as input to the algorithm. For respective target digital frames, known pixels of a source digital frame are propagated to the target digital frame based on a one-shot warping process (e.g., in which the computing device pull the known pixels of the source digital frames to fill the missing area in the target digital frame using the relationships defined by warping the optical flows). For example, for a target digital frame, i, the computing device loops through the source digital frames in two directions. In a first direction, for a source digital frame j that has an index greater than an index of i (e.g., the future digital frames), the computing device attaches w(Xⱼ,f_{i→j}) on

$${\hat{X}}_{i}^{f}$$

and updates

$${\hat{M}}_{i}^{f} .$$

In a second direction, for a source digital frame j that has an index less than an index of i (e.g., the past digital frames), the computing device attaches w(Xⱼ,f_{i→j}) on

$${\hat{X}}_{i}^{b}$$

and updates

$${\hat{M}}_{i}^{b} .$$

The process continues until the portion of the target digital frame is fully completed or the source digital frame does not have a next digital frame. After the propagation steps, the computing device obtains updated images (e.g., updated digital frames), \hat{X}, updated masks, \hat{M}, and an invalid propagation area V∈{0, 1}. For example, the computing device compares

$${\hat{X}}_{i}^{f} to {\hat{X}}_{i}^{b}$$

(e.g., for verification purposes), and calculates \hat{M}ᵢ, \hat{R}ᵢ, and \hat{V}ᵢ.

The computing device can provide the partially completed digital frames 212 as input to a learning model engine 216, and the learning model engine 216 can provide the completed reference digital frame 312 as output. The learning model engine 216 can be an example of, or can implement aspects of, the learning model engine 216 as described with reference to FIG. 2.

For example, after the internal pixel propagation engine 310 fills in (e.g., replaces, modifies, updates) one or more pixels in a masked portion of the masked digital frames 304 using the completed flows 308 and the masked digital frames 304, there can still be one or more remaining pixels in the masked portion (e.g., removed portion, portion to be updated) of the masked digital frames 304 that are to be filled in. For example, the computing device may be unable to complete the entirety of the masked portion of the masked digital frames 304 with intra-video knowledge, which includes knowledge obtained from other digital frames within a sequence of digital frames that define a digital video. The computing device can implement the learning model engine 216 to generate pixels for a remaining masked portion of a reference digital frame using one or more learning models and can propagate the generated pixels to other digital frames.

To prevent, or reduce, content conflict between different digital frames, the computing device can generate new contents for a single key digital frame, which is also referred to as a reference digital frame, instead of generating new contents for respective digital frames in a sequence independently. For example, the learning model engine 216 generating different pixel values for a single pixel across different digital frames can cause conflicting pixel values between the different digital frames, which leads to a digital video appearing blurry or inconsistent. Thus, the learning model engine 216 generates a single value per pixel in a masked portion of the reference digital frame to obtain a completed reference digital frame 312.

The computing device can select the reference digital frame by selecting a digital frame in a sequence with the greatest numerical quantity of connections to unknown pixels in other digital frames in the sequence. The connections can include, but are not limited to, respective mappings (e.g., relationships) between pixels, including pixel locations or indices, in the reference digital frame to the unknown pixels. The computing device can determine a count of the connections, Cᵢ, for a digital frame, i, according to Equation 2:

$${C}_{i} = {\sum }_{j = 0}^{L - 1} \{ {\sum }_{p} ( w ( , {f}_{i \to j} ) ⊙ {\hat{M}}_{i} ) \} , \qquad ( 2 )$$

where p indicates pixel index. The computing device can determine a reference digital frame, k, using the connection count of respective digital frames according to Equation 3:

$$k = arg {max}_{i} {C}_{i}$$

In some examples, after selecting a digital frame, k, as the reference digital frame, the computing device implements the learning model engine 216 to generate contents, including one or more pixel values, which satisfy (e.g., exceed, are greater than) a threshold quality value. For example, an accuracy and resolution of the generated pixel values satisfies a threshold accuracy and/or a threshold resolution for the reference digital frame. The learning model engine 216 can use one or more learning models to generate the pixel values, as described with reference to FIG. 2. For example, the learning model engine 216 can implement one or more diffusion learning models (e.g., stable diffusion based on a latent diffusion model). In some examples, the generated pixel values can replace and/or be used to update one or more pixel values within a masked portion of the reference digital frame to produce the completed reference digital frame 312. A completed reference digital frame 312 is a reference digital frame for which an entirety of a masked portion or region (a region or portion of the digital frame to be updated, a removed region or portion of the digital frame to be replaced, etc.) includes updated pixel values.

In some examples, the computing device can implement multiple modes for generating the content (e.g., two modes for content generation). For example, a first mode can include a removal mode and a second mode can include a generation mode. In the removal mode, the learning model engine 216 can produce contents that are based on the original images (e.g., the input digital frames 122). For example, if the computing device is to remove a foreground of the input digital frames 122 (e.g., the bear), then the learning model engine 216 can produce content that are visually similar to and/or maintain continuity with a background of the input digital frames 122 and/or the partially completed digital frames 212 (e.g., maintain one or more edges and other features of attributes in the background of the input digital frames 122 and/or the partially completed digital frames 212), which is described in further detail with respect to FIG. 4. In the generation mode, the learning model engine 216 can produce content that is not based on the original images (e.g., the input digital frames 122). For example, the learning model engine 216 can produce content that is visually different from and/or does not maintain continuity with the input digital frames 122 and/or the partially completed digital frames 212, which is described in further detail with respect to FIG. 5.

In some examples, the learning model engine 216 can provide a prompt 126 as input to the learning models. The learning models can perform language processing on the prompt 126 to determine whether to use the removal mode or the generation mode. For example, the learning model can process one or more terms (e.g., string values) in a prompt to determine an intent of the prompt 126. The intent of the prompt 126 can include a removal intent based on the terms being related to removing content from digital frames (“Empty background,” “Remove bear,” “No foreground,” etc.). Additionally, or alternatively, the prompt 126 can include generation intent based on the terms being related to generating new content in the digital frames (“Replace bear,” “Frog on the rock,” “New foreground,” etc.). In some cases, the computing device can configure or define the removal mode as a default mode (e.g., in one or more settings for an application for editing digital frames).

In some examples, the learning model engine 216 can implement any type of learning models, including one or more learning models for image inpainting. The prompt 126 can optionally be provided as input to the learning models, where one or more different types of learning models are capable of analyzing and using the prompt 126 to perform the image inpainting. For example, the learning model can be a type of learning model implemented for stable diffusion that takes a prompt 126 as input and can support both removal and addition by using different text inputs, as described with reference to FIG. 2. Additionally, or alternatively, the learning model engine 216 can implement other types of learning models (e.g., a learning model that supports the removal mode, and not the generation mode, that does not use a prompt 126 as input).

A reference digital frame pixel propagation engine 314 can use the completed flows 308 and the completed reference digital frame 312 to generate completed digital frames 210. The reference digital frame pixel propagation engine 314 can be an example of, or can implement aspects of, the pixel propagation engine 202 as described with reference to FIG. 2. Although the internal pixel propagation engine 310 and the reference digital frame pixel propagation engine 314 are illustrated as separate components, the internal pixel propagation engine 310 and the reference digital frame pixel propagation engine 314 can by implemented as a same component.

In some examples, the learning model engine 216 can generate pixels to complete the reference digital frame with a single reference digital frame. In some other examples, the computing device can implement the learning model engine 216 to generate pixels to at least partially complete a reference digital frame in a sequence, can implement the reference digital frame pixel propagation engine 314 to propagate the generated pixels to other digital frames in the sequence, can implement the learning model engine 216 to generate additional pixels to at least partially complete another reference digital frame in the sequence, and so on, until the digital frames in the sequence are completed. That is, the computing device can sequentially perform reference generation and propagation with multiple reference digital frames until an entire sequence of digital frames (e.g., that includes the reference digital frames) is completed. A completed digital frame 210 is a digital frame for which an entirety of a masked portion or region (a region or portion of the digital frame to be updated, a removed region or portion of the digital frame to be replaced, etc.) includes updated pixel values.

The reference digital frame pixel propagation engine 314 can propagate the generated pixels in the completed reference digital frame (e.g., a reference digital frame k) to the rest of the digital frames in the partially completed digital frames 212. For example, the reference digital frame pixel propagation engine 314 can perform a grid warping operation using the completed flows 308 according to Equation 4:

$${\tilde{X}}_{i} = {\hat{X}}_{i} + {\hat{M}}_{i} ⊙ w ( {\hat{X}}_{k} , {f}_{i \to k} ) , \qquad ( 4 )$$

where \tilde{X} indicates a set of images after reference propagation. For example, \tilde{X}, can include the completed digital frames 210 if a single reference digital frame is completed, or another set of partially completed digital frames if multiple reference digital frames are used to obtain a completed reference digital frame 312. Additionally, or alternatively, such as if multiple reference digital frames are used to obtain a completed reference digital frame 312, the computing device can obtain a set of masks, \tilde{M}, that indicate that the portion of the digital frames to be completed is not completed (e.g., has unknown pixel values and/or pixel values that have not yet been updated). If the set of images after reference propagation include another set of partially completed digital frames, then the reference digital frame pixel propagation engine 314 can provide (e.g., transmit) the other set of partially completed digital frames to the learning model engine 216 to generate new content for another reference digital frame. The reference digital frame pixel propagation engine 314 and the learning model engine can repeat the process until the reference digital frame and correspondingly the partially completed digital frames are completed.

The computing device can implement the verification engine 224 to confirm the accuracy of the completed digital frames 210. If the completed digital frames 210 satisfy a threshold accuracy (e.g., are greater than the threshold accuracy), then the verification engine 224 outputs the verified digital frames 316. If the completed digital frames 210 fail to satisfy the threshold accuracy (e.g., are less than the threshold accuracy), then the verification engine 224 uses the learning model engine 216 and/or implements one or more learning models to generate new or updated values for pixels that cause the completed digital frames 210 to fail to satisfy the threshold accuracy. Once the completed digital frames 210 satisfy the threshold accuracy, then the verification engine 224 outputs the verified digital frames 316.

In some examples, even after internal pixel propagation, pixel generation for a reference digital frame using learning models, and reference digital frame pixel propagation, the completed digital frames 210 can include one or more missing pixel values and/or pixel values within a region to be updated that have not been updated. Additionally, or alternatively, one or more pixel values within the completed digital frames 210 may be invalid pixel values that are detected (e.g., flagged) during the propagation verification. The invalid pixel values can include unreliably propagated pixel values. The computing device can perform a per-frame completion procedure to transform (e.g., fill, replace, modify, update) the missing pixel values, the pixel values that are not updated, and/or the invalid pixel values, which can be referred to as unverified pixels.

The per-frame completion procedure can include completing the unverified pixels for respective digital frame separately. For example, the computing device can implement a learning model, such as a CNN, which has an encoder-decoder architecture. The learning model may be referred to as a per-frame completion network, Y. The computing device can obtain a set of completed digital frames (e.g., verified digital frames 316) as an output from the per-frame completion network according to Equation 5:

$$Ψ ( \tilde{X} ⊙ ( 1 - V ) , \tilde{M} + V ) . \qquad ( 5 )$$

### Removal of Content for Transformation of Digital Frames

FIG. 4 depicts a visualization 400 of transforming a digital frame by removing attributes based on a text prompt. In some examples, the visualization 400 can include one or more learning models 218, which may be examples of the learning models 218 as described with reference to FIG. 2. In some examples, the learning models 218 are operable to receive a text prompt 402 and one or more digital frames 404 as input and generate one or more transformed digital frames 406.

In some variations, the text prompt 402 can include one or more string values, referred to as terms. The string values can represent natural language and commonly include one or more intents. For example, the intent of the string values can be to indicate to a computing device to remove a foreground object from a sequence of digital frames. The learning models 218 can include one or more natural language processing models configured (e.g., trained) to determine the intent of the string values. For example, a computing device can display one or more interactable elements to a user via a user interface of a computing device, as described with reference to FIG. 1. The user can provide user input via the interactable elements by filling in a text interactable element with the user input and/or by activating an interactable element that indicates the user is done filling in the text interactable element to the computing device, among other types of user input. In some variations, the user input can include the text prompt 402.

The computing device can provide the text prompt 402 as input to at least one learning model 218 (e.g., learning model trained to perform natural language processing). The learning models 218 can output an indication of an intent of the text prompt 402. For example, the intent of the text prompt 402 can be to remove a foreground attribute from a sequence of digital frames (e.g., including the digital frame 404). The learning models 218 can determine the intent from one or more terms in the text prompt 402. The terms “Empty background” can correspond to an intent to remove attributes from a foreground of the image. The terms “high resolution,” can correspond to an intent to replace the removed attributes with a content that satisfies (e.g., exceeds, is greater than) a threshold resolution value.

If the learning models 218 determine that the intent of the text prompt 402 is to remove attributes from a digital frame 404, then the computing device can implement a removal mode when transforming the digital frame 404. In a removal mode, the transformation includes removing an attribute from the digital frame 404 and replacing the attribute with generated content that is visually similar to a background in the digital frame 404 and/or maintains a continuity with the background in the digital frame 404.

The learning models 218 can generate pixel values to complete (e.g., fill, update, replace) values of pixels within a region defined by the mask. The generated pixel values can align with the attributes in the background of the digital frame 404, such as by completing one or more shadows, edges of attributes, maintaining visually similar patterns, maintaining visually similar color, and/or maintaining visually similar texture of different attributes that extend into the masked region, among other features. For example, the generated pixel values can include a continuation of a rock attribute, a wall texture, and a ground texture, among other examples from the visualization 400. The computing device can obtain the transformed digital frame 406 by replacing pixel values removed from the digital frame 404 with the generated pixel values.

The computing device can provide one or more digital frames 404 as input to the learning models 218 (e.g., to the same learning models that analyze the intent of the text prompt 402 and/or different learning models). The digital frames 404 can include original digital frames and masks that indicate a portion to be removed from the digital frames. Additionally, or alternatively, the digital frames 404 can include original digital frames, and the learning models 218 can generate masks based on the text prompt. For example, if the text prompt includes the terms, “Remove bear, empty background,” then the learning models 218 can output masks that outline the bear to be removed.

In some examples, the removal mode can be a default setting configured by user input and/or by a computing device. Thus, the computing device can remove one or more attributes from digital frames 404 that are provided without a text prompt 402 and/or are provided with a text prompt 402 that does not include an intent. In some variations, if the learning models 218 are unable to output an intent for a text prompt 402, then the computing device can display an additional interactable element and a message requesting an additional text prompt via a user interface. The computing device can receive the additional text prompt as user input via the user interface and can provide the additional text prompt as input to the learning models 218 to obtain an intent of the text prompt 402.

Although the visualization 400 is illustrated as including a single digital frame 404, and a single transformed digital frame 406, the visualization 400 can include any numerical quantity of digital frames and corresponding transformed digital frames.

### Generation of New Content for Transformation of Digital Frames

FIG. 5 depicts a visualization 500 of transforming a digital frame by generating new attributes using based on a text prompt. In some examples, the visualization 500 can include one or more learning models 218, which may be examples of the learning models 218 as described with reference to FIGS. 2 and 4. In some examples, the learning models 218 are operable to receive a text prompt 502 and one or more digital frames 504 as input and generate one or more transformed digital frames 506.

In some variations, the text prompt 502 can include one or more string values, referred to as terms. The string values can represent natural language and commonly include one or more intents. For example, the intent of the string values can be to indicate to a computing device to generate new attributes within a sequence of digital frames and/or to update existing attributes within a sequence of digital frames with new pixel values. The learning models 218 can include one or more natural language processing models configured (e.g., trained) to determine the intent of the string values. For example, a computing device can display one or more interactable elements to a user via a user interface of a computing device, as described with reference to FIG. 1. The user can provide user input via the interactable elements by filling in a text interactable element with the user input and/or by activating an interactable element that indicates the user is done filling in the text interactable element to the computing device, among other types of user input. In some variations, the user input can include the text prompt 502.

The computing device can provide the text prompt 502 as input to at least one learning model 218 (e.g., learning model trained to perform natural language processing). The learning models 218 can output an indication of an intent of the text prompt 502. For example, the intent of the text prompt 502 can be to generate a new foreground attribute in a sequence of digital frames (e.g., including the digital frame 504). The learning models 218 can determine the intent from one or more terms in the text prompt 402. The terms “Frog on the rock” can correspond to an intent to add a new attribute (e.g., the “frog”) to an existing attribute (“the rock”) to a foreground of the image. The terms “high resolution,” can correspond to an intent to generate new pixel values for attributes that provides content that satisfies (e.g., exceeds, is greater than) a threshold resolution value.

If the learning models 218 determine that the intent of the text prompt 502 is to generate new attributes or modify an existing attribute of a digital frame 504, then the computing device can implement a generation mode when transforming the digital frame 504. In a generation mode, the transformation includes modifying or updating one or more pixel values in the digital frame 504 with new or updated pixel values. The new or updated pixel values can provide for new attributes and/or content within the digital frame 504 that is not visually similar and/or does not maintain a continuity with existing attributes in the digital frame 504.

The learning models 218 can generate pixel values to complete (e.g., fill, update, replace) values of pixels within a region defined by the mask. The generated pixel values can align with the text prompt 502 and can include new or updated attributes, such as by applying a visual effect to the digital frame 504 and/or generating an attribute indicated by the text prompt 502, among other examples. For example, the generated pixel values can include values for a frog sitting on a rock, among other examples from the visualization 500. The computing device can obtain the transformed digital frame 506 by updating existing pixel values in the digital frame 504 with the generated pixel values.

The computing device can provide one or more digital frames 504 as input to the learning models 218 (e.g., to the same learning models that analyze the intent of the text prompt 502 and/or different learning models). The digital frames 504 can include original digital frames and masks that indicate a portion to be updated within the digital frames. Additionally, or alternatively, the digital frames 504 can include original digital frames, and the learning models 218 can generate masks based on the text prompt. For example, if the text prompt includes the terms, “Add frog to foreground,” then the learning models 218 can output masks that outline a region of the digital frame 504 that is in a foreground and already includes a rock and/or a frog, if present.

In some variations, if the learning models 218 are unable to output an intent for a text prompt 502, then the computing device can display an additional interactable element and a message requesting an additional text prompt via a user interface. The computing device can receive the additional text prompt as user input via the user interface and can provide the additional text prompt as input to the learning models 218 to obtain an intent of the text prompt 502. Although the visualization 500 is illustrated as including a single digital frame 504, and a single transformed digital frame 506, the visualization 500 can include any numerical quantity of digital frames and corresponding transformed digital frames.

### Transformation of Digital Frames Using Multiple Masks

FIG. 6 depicts a visualization 600 of transforming a digital frame using multiple masks. In some examples, a computing device (e.g., a computing device 102, as described with reference to FIG. 1) can receive one or more input digital frames 602 that includes multiple masks. For example, the input digital frames 602 can include a mask 604-a and a mask 604-b. The computing device can use the multiple masks to improve a performance of a process for transforming digital frames.

In some examples, an input digital frame 602 can include one or more occlusions. An occlusion refers to the blocking or covering (e.g., overlapping) of one attribute in an input digital frame 602 by another attribute in the input digital frame 602. Occlusions occur when one attribute moves in front of another attribute, partially or completely obscuring at least one of the attributes from view.

For transforming digital frames, the computing device can use an optical flow that is consistent with background contents or attributes of the digital frames. However, the motion of the occluding object can disrupt the flow completion process (e.g., to obtain completed flows, as described with reference to FIG. 3), which can cause propagation errors. To prevent or reduce the propagation errors due to occlusions, the computing device can use multiple masks. In some examples, the computing device can obtain (e.g., as user input, from a learning model) a mask of a target attribute to be removed or updated, which is referred to as a negative mask. For example, in the visualization 600, the mask 604-b is a negative mask. The computing device can also obtain a mask of an attribute that occludes the target attribute, which is referred to as a positive mask. For example, in the visualization 600, the mask 604-a is a positive mask. Before inference, the computing device can define a union of the negative mask and the positive mask (e.g., the mask 604-b and the mask 604-a, respectively) as a temporary target mask.

After the input digital frame 602 is transformed, the original contents of the positive mask (e.g., the mask 604-a) are combined with the output images, as the target attributes should be removed from the input digital frames 602. That is, the computing device can use the union of the negative mask and the positive mask to transform the input digital frame 602, and can store the contents (e.g., pixel values) within the outline of the positive mask (e.g., the mask 604-a) for use after the transformation or completion of the input digital frame 602. Once the input digital frame 602 is transformed or completed, then the computing device can replace contents within the positive mask of the transformed or completed digital frame with the stored contents (e.g., pixel values).

In some examples, the results of the transformation of the input digital frame 602 using the mask 604-a and the mask 604-b are illustrated in the visualization 600. For example, the visualization 600 includes a true completed digital frame 606, for reference. The completed digital frame without an additional mask 608 (e.g., with a single mask, such as the mask 604-b) includes an incorrectly transformed portion due to the occlusion. The completed digital frame with the additional mask 610 (e.g., with multiple masks, such as the mask 604-a and the mask 604-b) includes a correctly transformed portion.

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not limited to the orders shown for performing the operations by the respective blocks.

### Example Procedures for Transformation of Digital Frames

FIG. 7 is a flow diagram depicting an algorithm as a step-by-step procedure 700 in an example implementation of the digital frame transformation engine, which is performable by a computing device to transform digital frames using relationships between the digital frames. In some examples, the step-by-step procedure 700 can be executed by a digital frame transformation engine, such as a digital frame transformation engine 116, as described with reference to FIGS. 1 and 2. In some other examples, the step-by-step procedure 700 can be executed by any computing device, such as a computing device 102 and/or one or more components of a computing device 102, as described with reference to FIG. 1.

A set of digital frames and a set of masks is received (block 702). For example, the digital frame transformation engine receives user input that indicates the set of digital frames and/or the set of masks. Respective digital frames can have respective masks, such that the masks can be applied to the digital frames in the set. The digital frames can include a sequence of digital frames that make up a digital video, as described with reference to FIG. 1. In some examples, a digital frame can include one or more attributes. Example attributes include, but are not limited to, characteristics of objects in the digital frames (size, shape, color values, texture, etc.), surfaces in the digital frames, edges (e.g., of a visual scene) in the digital frames, texture of different portions or regions of the digital frames, pattern of different portions or regions of the digital frames, color values of different portions or regions of the digital frames, and/or other features.

A mask can include a define region or portion of a digital frame. For example, the mask can outline an attribute in the digital frame to be transformed. In some variations, the masks are provided by user input. In some other variations, a computing device and/or the digital frame transformation engine generate the masks using one or more learning models. The masks can include a first set of masks that define a target attribute to be transformed (e.g., replaced, updated) and a second set of masks that define another attribute that at least partially overlaps with the target attribute, as described with reference to FIG. 6. For example, the target attribute and the other attribute can have one or more overlapping features, such that the target attribute covers the features of the other attribute from view, or vice-versa, which disrupts a pixel value continuity of the attributes. That is, the pixel values can change for different attributes (e.g., disrupting continuity). The digital frame transformation engine can define a union of the second set of masks that define the other attribute and the first set of masks that define the target attribute as a temporary target set of masks. The digital frame transformation engine can store the original contents of the set of masks that define the target attribute, such that once the mask are combined with the output images, as the target attributes should be removed from the input digital frames.

Displacements of attributes between sequential digital frames of the set of digital frames are determined (block 704). For example, the digital frame transformation engine can perform grid warping to obtain a displacement (e.g., movement) of a pixel across sequential digital frames, and can store the displacements of the pixels as relationships between the digital frames.

In some examples, the grid warping includes the digital frame transformation engine applying a grid overlay to a digital frame in a sequence of digital frames. The digital frame transformation engine can transform the grid overlay using respective displacements of attributes or pixels within the attributes between the digital frame and subsequent digital frames in the sequence. The digital frame transformation engine can obtain a mapping between pixel values of the first digital frame and corresponding pixel values of the subsequent digital frames using the grid overlay as a reference and using the respective displacements of the attributes or pixels within the attributes.

One or more pixel values associated with a portion of at least one digital frame of the set of digital frames are obtained based on one or more corresponding pixel values associated with other digital frames of the set of digital frames and the displacements of the attributes (block 706). The portion of the at least one digital frame is defined using at least one mask of the set of masks. For example, the digital frame transformation engine can traverse the digital frames from a target digital frame to obtain pixel values for the target digital frame. The digital frame transformation engine can repeat the process for respective digital frames in a sequence of digital frames.

The digital frame transformation engine can obtain pixel values (e.g., for a portion of the target digital frame that is masked) by mapping the one or more pixel values for a target digital frame to the one or more corresponding pixel values of other digital frames in the sequence of digital frames, referred to as source digital frames, using the respective relationships between the target digital frame and the source digital frames. In some examples, the digital frame transformation engine obtains one or more first pixel values (e.g., for a portion of the target digital frame that is masked) by traversing the sequence of digital frames in a first direction, such as a forward direction. The digital frame transformation engine obtains one or more second pixel values (e.g., for a portion of the target digital frame that is masked) by traversing the sequence of digital frames in a second direction, such as a backward direction. The directions can be opposite and can be related to a timing or order of the digital frames.

The digital frame transformation engine can determine (e.g., calculate, compute) respective differences between the one or more first pixel values and the one or more second pixel values. For example, for the pixels that the digital frame transformation engine has obtained first and second pixel values, the digital frame transformation engine can subtract the first pixel value for a pixel from the second pixel value for that pixel. If the difference in pixel values for a pixel satisfies (e.g., is less than, does not exceed) a threshold value, then the digital frame transformation engine can use an average value between first pixel value and the second pixel value to transform the pixel. If the difference in pixel values for a pixel fails to satisfy (e.g., is greater than or equal to, exceeds) the threshold value, then the digital frame transformation engine can obtain a pixel value for the pixel as output from a learning model by providing the digital frame that includes the pixel as input to the learning model. The digital frame transformation engine can use the pixel value that is output from the learning model to transform the pixel.

The portion of the at least one digital frame is transformed based on the one or more pixel values (block 708). In some examples, the digital frame transformation engine can transform one or more pixel values of a portion of a digital frame defined by the mask by removing one or more original pixel values of the portion and replacing the one or more original pixel values with the one or more pixel values obtained by the digital frame transformation engine (e.g., in a removal mode). Additionally, or alternatively, the digital frame transformation engine can transform one or more pixel values of a portion of a digital frame defined by the mask by updating one or more original pixel values of the portion using the one or more pixel values obtained by the digital frame transformation engine (e.g., in a generation mode). Updating the one or more original pixel values can include modifying a pixel value to create a visual effect at the digital frame and/or replacing the original pixel values with different pixel values to create the visual effect at the digital frame.

In some examples, the digital frame transformation engine can generate one or more additional pixel values for a reference digital frame that is in the sequence of digital frames by providing the reference digital frame and a mask as input to a learning model (e.g., a generative AI model). For example, the digital frame transformation engine determines one or more remaining pixels of a portion of a digital frame to be transformed are not transformed after transforming the portion of the digital frame. The digital frame transformation engine can transform one or more original pixel values of the reference digital frame using the one or more additional pixel values. The digital frame transformation engine can obtain updated relationships between the digital frames in the sequence of digital frames in response to transforming the one or more original pixel values of the reference digital frame. For example, the digital frame transformation engine can obtain the updated relationships by determining updated respective displacements of the attributes of the digital frames in the sequence. In some cases, the updated respective displacements of the attributes occur between the sequential digital frames in the sequence of digital frames. The digital frame transformation engine can obtain one or more additional pixel values for the target digital frame based on one or more corresponding pixel values of the other digital frames of the sequence of digital frames and the updated relationships. The digital frame transformation engine can transform one or more original pixel values of the at least one digital frame using the one or more additional pixel values.

In some examples, the digital frame transformation engine can select the reference digital frame from the sequence of digital frames by selecting the digital frame with the greatest numerical quantity of connections to pixel values within a portion of other digital frames in the sequence of digital frames (e.g., that maximizes the numerical quantity of connections). The portion of the other digital frames can be defined by respective masks that are applied to the other digital frames. In some examples, the pixel values are generated by the learning model based on a prompt. For example, the digital frame transformation engine can obtain a prompt via one or more interactable elements of a user interface that includes or indicates an intent for the transforming of the one or more original pixel values of the reference digital frame. The digital frame transformation engine can determine that the intent is to replace the one or more original pixel values to remove at least one attribute from the digital frame and/or that the intent is to update the one or more original pixel values to add a new attribute to the reference digital frame or to modify an existing attribute of the reference digital frame.

FIG. 8 is a flow diagram depicting an algorithm as a step-by-step procedure 800 in an example implementation of the digital frame transformation engine, which is performable by a computing device to transform digital frames using relationships between the digital frames. In some examples, the step-by-step procedure 800 can be executed by a digital frame transformation engine, such as a digital frame transformation engine 116, as described with reference to FIGS. 1 and 2. In some other examples, the step-by-step procedure 800 can be executed by any computing device, such as a computing device 102 and/or one or more components of a computing device 102, as described with reference to FIG. 1.

A set of masked digital frames is obtained based on applying a set of masks to a set of digital frames (block 802). For example, the digital frame transformation engine receives user input that indicates the set of digital frames, a prompt, and/or the set of masks. If the user input does not include the set of masks, then the digital frame transformation engine can generate the set of masks by providing the set of digital frames and the prompt to a learning model. The learning model can output the set of masks by determining one or more pixels to transform in the digital frames using the prompt and the digital frames. The digital frame transformation engine can apply the masks to the digital frames by overlaying respective masks to respective digital frames.

The digital frames can include a sequence of digital frames that make up a digital video, as described with reference to FIG. 1. In some examples, a digital frame can include one or more attributes. Example attributes include, but are not limited to, characteristics of objects in the digital frames (size, shape, color values, texture, etc.), surfaces in the digital frames, edges (e.g., of a visual scene) in the digital frames, texture of different portions or regions of the digital frames, pattern of different portions or regions of the digital frames, color values of different portions or regions of the digital frames, and/or other features.

A mask can include a define region or portion of a digital frame. For example, the mask can outline an attribute in the digital frame to be transformed. The masks can include a first set of masks that define a target attribute to be transformed (e.g., replaced, updated) and a second set of masks that define another attribute that at least partially overlaps with the target attribute, as described with reference to FIG. 6. For example, the target attribute and the other attribute can have one or more overlapping features, such that the target attribute covers the features of the other attribute from view, or vice-versa, which disrupts a pixel value continuity of the attributes. That is, the pixel values can change for different attributes (e.g., disrupting continuity). The digital frame transformation engine can define a union of the second set of masks that define the other attribute and the first set of masks that define the target attribute as a temporary target set of masks. The digital frame transformation engine can store the original contents of the set of masks that define the target attribute, such that once the mask are combined with the output images, as the target attributes should be removed from the input digital frames.

A mapping between a set of pixels associated with the set of masked digital frames is obtained based on traversing the set of masked digital frames to obtain respective displacements of the set of pixels occurring between sequential masked digital frames of the set of masked digital frames (block 804). For example, the digital frame transformation engine can perform grid warping to obtain a displacement (e.g., movement) of a pixel across sequential digital frames, and can store the displacements of the pixels to use to map the pixel location and/or value between the digital frames.

In some examples, the grid warping includes the digital frame transformation engine applying a grid overlay to a digital frame in a sequence of digital frames. The digital frame transformation engine can transform the grid overlay using respective displacements of attributes or pixels within the attributes between the digital frame and subsequent digital frames in the sequence. The digital frame transformation engine can obtain the mapping between pixel values and/or pixel locations of the first digital frame and corresponding pixel values and/or locations of the subsequent digital frames using the grid overlay as a reference and using the respective displacements of the attributes or pixels within the attributes.

One or more pixel values associated with at least one masked digital frame of the set of masked digital frames are obtained based on one or more corresponding pixel values associated with other masked digital frames of the set of masked digital frames and the mapping between the set of pixels associated with the set of masked digital frames (block 806). For example, the digital frame transformation engine can traverse the digital frames from a target digital frame to obtain pixel values for the target digital frame. The digital frame transformation engine can repeat the process for respective digital frames in a sequence of digital frames.

The digital frame transformation engine can obtain pixel values (e.g., for a portion of the target digital frame that is masked) by referencing a mapping between the one or more pixel values for a target digital frame and the one or more corresponding pixel values of other digital frames in the sequence of digital frames, referred to as source digital frames. In some examples, the digital frame transformation engine obtains one or more first pixel values (e.g., for a portion of the target digital frame that is masked) by traversing the sequence of digital frames in a first direction, such as a forward direction. The digital frame transformation engine obtains one or more second pixel values (e.g., for a portion of the target digital frame that is masked) by traversing the sequence of digital frames in a second direction, such as a backward direction. The directions can be opposite and can be related to a timing or order of the digital frames.

The digital frame transformation engine can determine (e.g., calculate, compute) respective differences between the one or more first pixel values and the one or more second pixel values. For example, for the pixels that the digital frame transformation engine has obtained first and second pixel values, the digital frame transformation engine can subtract the first pixel value for a pixel from the second pixel value for that pixel. If the difference in pixel values for a pixel satisfies (e.g., is less than, does not exceed) a threshold value, then the digital frame transformation engine can use an average value between first pixel value and the second pixel value to transform the pixel. If the difference in pixel values for a pixel fails to satisfy (e.g., is greater than or equal to, exceeds) the threshold value, then the digital frame transformation engine can obtain a pixel value for the pixel as output from a learning model by providing the digital frame that includes the pixel as input to the learning model. The digital frame transformation engine can use the pixel value that is output from the learning model to transform the pixel.

The at least one masked digital frame is transformed based on the one or more pixel values associated with the at least one masked digital frame (block 808). In some examples, the digital frame transformation engine can transform one or more pixel values of a portion of a masked digital frame (e.g., a portion or region defined by the mask applied to the digital frame) by removing one or more original pixel values of the portion and replacing the one or more original pixel values with the one or more pixel values obtained by the digital frame transformation engine (e.g., in a removal mode). Additionally, or alternatively, the digital frame transformation engine can transform one or more pixel values of a portion of a digital frame defined by the mask by updating one or more original pixel values of the portion using the one or more pixel values obtained by the digital frame transformation engine (e.g., in a generation mode). Updating the one or more original pixel values can include modifying a pixel value to create a visual effect at the digital frame and/or replacing the original pixel values with different pixel values to create the visual effect at the digital frame.

In some examples, the digital frame transformation engine can generate one or more additional pixel values for a reference digital frame that is in the sequence of digital frames by providing the reference digital frame and a mask as input to a learning model (e.g., a generative AI model). For example, the digital frame transformation engine determines one or more remaining pixels of a portion of a masked digital frame to be transformed are not transformed after transforming the portion of the masked digital frame. The digital frame transformation engine can transform one or more original pixel values of the reference digital frame using the one or more additional pixel values. The digital frame transformation engine can obtain updated relationships between the masked digital frames in the sequence of masked digital frames in response to transforming the one or more original pixel values of the reference digital frame. For example, the digital frame transformation engine can obtain the updated relationships by determining updated respective displacements of the attributes of the masked digital frames in the sequence. In some cases, the updated respective displacements of the attributes occur between the sequential masked digital frames in the sequence of masked digital frames. The digital frame transformation engine can obtain one or more additional pixel values for the target digital frame based on one or more corresponding pixel values of the other digital frames of the sequence of masked digital frames and the updated relationships. The digital frame transformation engine can transform one or more original pixel values of the at least one masked digital frame using the one or more additional pixel values.

In some examples, the digital frame transformation engine can select the reference digital frame from the sequence of masked digital frames by selecting a masked digital frame with the greatest numerical quantity of connections to pixel values within a portion of other digital frames in the sequence of digital frames (e.g., that maximizes the numerical quantity of connections). The portion of the other masked digital frames can be defined by respective masks that are applied to the other masked digital frames. In some examples, the pixel values are generated by the learning model based on a prompt. For example, the digital frame transformation engine can obtain a prompt via one or more interactable elements of a user interface that includes or indicates an intent for the transforming of the one or more original pixel values of the reference digital frame. The digital frame transformation engine can determine that the intent is to replace the one or more original pixel values to remove at least one attribute from the digital frame and/or that the intent is to update the one or more original pixel values to add a new attribute to the reference digital frame or to modify an existing attribute of the reference digital frame.

FIG. 9 is a flow diagram depicting an algorithm as a step-by-step procedure 800 in an example implementation of the digital frame transformation engine, which is performable by a computing device to transform digital frames according to an intent of a prompt and by generating pixel values for transforming the digital frames that correspond to the intent. In some examples, the step-by-step procedure 900 can be executed by a digital frame transformation engine, such as a digital frame transformation engine 116, as described with reference to FIGS. 1 and 2. In some other examples, the step-by-step procedure 900 can be executed by any computing device, such as a computing device 102 and/or one or more components of a computing device 102, as described with reference to FIG. 1.

A prompt corresponding to an intent associated with transforming of one or more respective original pixel values associated with a set of digital frames is obtained via one or more interactable elements of a user interface associated with a computing device (block 902). For example, the digital frame transformation engine receives user input that indicates the set of digital frames, the prompt, and/or a set of masks. If the user input does not include the set of masks, then the digital frame transformation engine can generate the set of masks by providing the set of digital frames and the prompt to a learning model. The learning model can output the set of masks by determining one or more pixels to transform in the digital frames using the prompt and the digital frames. The digital frame transformation engine can apply the masks to the digital frames by overlaying respective masks to respective digital frames. In some examples, a digital frame can include one or more attributes, as described with reference to FIG. 8.

One or more pixel values associated with a digital frame of the set of digital frames are generated based on providing the set of digital frames and the prompt as input to a learning model, where the one or more pixel values correspond to the intent (904). For example, the digital frame transformation engine can implement a learning model trained to provide the pixel values as output given the prompt and the digital frames as input. In some examples, the digital frame transformation engine can select the digital frame (e.g., a reference digital frame) from the set of masked digital frames by selecting a masked digital frame with a greatest numerical quantity of connections to pixel values within a portion of other digital frames in the sequence of digital frames (e.g., that maximizes the numerical quantity of connections). The portion of the other masked digital frames can be defined by respective masks that are applied to the other masked digital frames.

The one or more respective original pixel values associated with the digital frame are transformed based on the one or more pixel values associated with the digital frame (906). For example, the digital frame transformation engine can determine that the intent is to replace the one or more respective original pixel values to remove at least one attribute from the digital frame. The digital frame transformation engine removes the one or more original pixel values from the digital frame and replaces them with the one or more pixel values generated by the learning model. In some other examples, the digital frame transformation engine can determine that the intent is to update the one or more respective original pixel values to add a new attribute to the digital frame or to modify an existing attribute of the digital frame. The digital frame transformation engine can update the original pixel values of the digital frame using the one or more pixel values generated by the learning model. In some variations, the digital frame transformation engine can use natural language processing techniques to determine the intent, as described with reference to FIG. 2.

Relationships between respective digital frames in the set of digital frames are obtained based on respective displacements of attributes associated with the respective digital frames and in response to transforming the one or more respective original pixel values of the digital frame, where the respective displacements of the attributes occur between sequential digital frames in the set of digital frames (block 908). For example, the digital frame transformation engine can perform grid warping to obtain a displacement (e.g., movement) of a pixel across sequential digital frames, and can store the displacements of the pixels to use to map the pixel location and/or value between the digital frames.

One or more pixel values associated with at least one digital frame of the set of digital frames are obtained based on one or more corresponding pixel values associated with other digital frames of the set of digital frames and the relationships between the respective digital frames in the set of digital frames (block 910). For example, the digital frame transformation engine can traverse the digital frames from a target digital frame to obtain pixel values for the target digital frame. The digital frame transformation engine can repeat the process for respective digital frames in a sequence of digital frames.

One or more original pixel values associated with the at least one digital frame are transformed based on the one or more pixel values associated with the at least one digital frame (block 910). In some examples, the digital frame transformation engine can transform one or more pixel values of a portion of a masked digital frame (e.g., a portion or region defined by the mask applied to the digital frame) by removing one or more original pixel values of the portion and replacing the one or more original pixel values with the one or more pixel values obtained by the digital frame transformation engine (e.g., in a removal mode). Additionally, or alternatively, the digital frame transformation engine can transform one or more pixel values of a portion of a digital frame defined by the mask by updating one or more original pixel values of the portion using the one or more pixel values obtained by the digital frame transformation engine (e.g., in a generation mode).

### Example System and Device

FIG. 10 illustrates an example system including various components of an example device that can be implemented as any type of computing device as described and/or utilized with reference to FIGS. 1 through 9 to implement examples of the techniques described herein. FIG. 10 illustrates an example system generally at 1000 that includes an example computing device 1002 that is representative of one or more computing systems and/or devices that implement the various techniques described herein. This is illustrated through inclusion of the digital frame transformation engine 116. The computing device 1002 is configurable, for example, as a server of a service provider, as a device associated with a client (e.g., a client device), as an on-chip system, and/or as any other suitable computing device or computing system.

The example computing device 1002 as illustrated includes a processing system 1004, one or more computer-readable media 1006, one or more I/O interface 1008, and/or a digital frame transformation engine 116 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed, or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read-only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed, in some examples, to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supported by various configurations of the computing device 1002 and are not limited to the specific examples of the techniques described herein. This functionality is also implementable or partially implementable through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device example, implementation of functionality described herein is distributable throughout the system 1000. For example, the functionality is implementable in part on the computing device 1002 as well as via the platform 1016 that abstracts the functionality of the cloud 1014.

Although the techniques have been described in language specific to structural features and/or methodological acts, it is to be understood that the techniques defined in the appended claims are not limited to the specific features or acts described. Rather, the specific features and acts are disclosed as example forms of implementing the claims.

What is claimed is:

1. A method comprising:
receiving, by a computing device, a plurality of digital frames and a plurality of masks;
determining, by the computing device, displacements of attributes between sequential digital frames of the plurality of digital frames;
obtaining, by the computing device, one or more pixel values associated with a portion of at least one digital frame of the plurality of digital frames based on one or more corresponding pixel values associated with other digital frames of the plurality of digital frames and the displacements of the attributes, the portion of the at least one digital frame defined using at least one mask of the plurality of masks; and
transforming, by the computing device, the portion of the at least one digital frame based on the one or more pixel values.

2. The method of claim 1, wherein transforming the portion of the at least one digital frame comprises:
removing one or more original pixel values associated with the portion of the at least one digital frame; and
replacing the one or more original pixel values associated with the portion of the at least one digital frame with the one or more pixel values associated with the portion of the at least one digital frame.

3. The method of claim 1, wherein transforming the portion of the at least one digital frame comprises updating one or more original pixel values associated with the portion of the at least one digital frame based on the one or more pixel values associated with the portion of the at least one digital frame.

4. The method of claim 1, further comprising:
generating, by the computing device and based on providing the at least one digital frame and the at least one mask as input to a learning model, one or more additional pixel values associated with a digital frame of the at least one digital frame;
transforming, by the computing device, one or more original pixel values associated with the digital frame based on the one or more additional pixel values associated with the digital frame;
obtaining, by the computing device and in response to transforming the one or more original pixel values of the digital frame, updated displacements of the attributes between the sequential digital frames;
obtaining, by the computing device, one or more additional pixel values associated with the at least one digital frame based on one or more corresponding pixel values associated with the other digital frames of the plurality of digital frames and the updated displacements of the attributes; and
transforming, by the computing device, one or more original pixel values associated with the at least one digital frame based on the one or more additional pixel values.

5. The method of claim 4, further comprising selecting, by the computing device, the digital frame from the plurality of digital frames that maximizes a numerical quantity of connections to pixel values within a portion of other digital frames in the plurality of digital frames, the portion of the other digital frames defined using respective masks of the plurality of masks.

6. The method of claim 4, wherein generating the one or more additional pixel values comprises:
obtaining, via one or more interactable elements of a user interface associated with the computing device, a prompt corresponding to an intent associated with the transforming of the one or more original pixel values associated with the digital frame; and
determining the intent is associated with replacing the one or more original pixel values to remove at least one attribute associated with the digital frame from the digital frame; or
determining the intent is associated with updating the one or more original pixel values to add a new attribute associated with the digital frame or to modify an existing attribute associated with the digital frame.

7. The method of claim 4, wherein generating the one or more additional pixel values comprises determining, after transforming the portion of the at least one digital frame, one or more remaining pixels of the portion of the at least one digital frame are to be transformed.

8. The method of claim 1, wherein obtaining the one or more pixel values associated with the portion of the at least one digital frame comprises mapping the one or more pixel values associated with the portion of the at least one digital frame to the one or more corresponding pixel values associated with the other digital frames based on respective displacements of the attributes between the at least one digital frame and the other digital frames.

9. The method of claim 1, further comprising:
applying a grid overlay to a first digital frame in the plurality of digital frames;
transforming the grid overlay based on respective displacements of the attributes between the first digital frame and subsequent digital frames of the plurality of digital frames; and
obtaining, using the grid overlay as a reference and based on the respective displacements of the attributes, a mapping between pixel values associated with the first digital frame and corresponding pixel values associated with the subsequent digital frames, the one or more pixel values obtained based on the mapping.

10. The method of claim 1, wherein obtaining the one or more pixel values associated with the portion of the at least one digital frame comprises:
obtaining one or more first pixel values associated with the portion of the at least one digital frame based on traversing the plurality of digital frames in a first direction;
obtaining one or more second pixel values associated with the portion of the at least one digital frame based on traversing the plurality of digital frames in a second direction, the first direction being different than the second direction; and
determining respective differences between the one or more first pixel values associated with the portion of the at least one digital frame and the one or more second pixel values associated with the portion of the at least one digital frame.

11. The method of claim 10, further comprising obtaining, for pixels corresponding to differences of the respective differences that satisfy a threshold value, an average value between first pixel values of the one or more first pixel values that correspond to the pixels and second pixel values of the one or more second pixel values that correspond to the pixels, the one or more pixel values associated with the portion of the at least one digital frame including the average value.

12. The method of claim 10, further comprising obtaining, for pixels corresponding to differences of the respective differences that fail to satisfy a threshold value, respective pixel values associated with the pixels as output from a learning model based on providing the at least one digital frame as input to the learning model, the one or more pixel values associated with the portion of the at least one digital frame including the respective pixel values associated with the pixels.

13. The method of claim 1, wherein the plurality of masks includes one or more of a first plurality of masks associated with a target attribute to be transformed or a second plurality of masks associated with an attribute that at least partially overlaps with the target attribute in the at least one digital frame, the first plurality of masks defining the portion of the at least one digital frame.

14. A system comprising:
a memory component; and
a computing device coupled to the memory component, the computing device to perform operations including:
obtaining a plurality of masked digital frames based on applying a plurality of masks to a plurality of digital frames;
generating a mapping between a plurality of pixels associated with the plurality of masked digital frames based on traversing the plurality of masked digital frames to obtain respective displacements of the plurality of pixels occurring between sequential masked digital frames of the plurality of masked digital frames;
obtaining one or more pixel values associated with at least one masked digital frame of the plurality of masked digital frames based on one or more corresponding pixel values associated with other masked digital frames of the plurality of masked digital frames and the mapping between the plurality of pixels associated with the plurality of masked digital frames; and
transforming the at least one masked digital frame based on the one or more pixel values associated with the at least one masked digital frame.

15. The system of claim 14, wherein to transform the at least one masked digital frame the operations further include:
removing one or more original pixel values associated with the at least one masked digital frame; and
replacing the one or more original pixel values associated with the at least one masked digital frame with the one or more pixel values associated with the at least one masked digital frame.

16. The system of claim 14, wherein to transform the at least one masked digital frame the operations further include updating one or more original pixel values associated with the at least one masked digital frame based on the one or more pixel values associated with the at least one masked digital frame.

17. The system of claim 14, wherein the operations further include:
generating, based on providing the at least one masked digital frame as input to a learning model, one or more additional pixel values associated with a masked digital frame of the at least one masked digital frame;
transforming one or more original pixel values associated with the masked digital frame based on the one or more additional pixel values associated with the masked digital frame;
generating, in response to transforming the one or more original pixel values of the masked digital frame, an updated mapping between the plurality of pixels associated with the plurality of masked digital frames based on traversing the plurality of masked digital frames to obtain updated respective displacements of the plurality of pixels occurring between the sequential masked digital frames in the plurality of masked digital frames;
obtaining one or more additional pixel values associated with the at least one masked digital frame based on one or more corresponding pixel values associated with the other masked digital frames of the plurality of masked digital frames and the updated mapping between the plurality of pixels associated with the plurality of masked digital frames; and
transforming one or more original pixel values associated with the at least one masked digital frame based on the one or more additional pixel values associated with the at least one masked digital frame.

18. A method comprising:
obtaining, via one or more interactable elements of a user interface associated with a computing device, a prompt corresponding to an intent associated with transforming of one or more respective original pixel values associated with a plurality of digital frames;
generating, by the computing device and based on providing the plurality of digital frames and the prompt as input to a learning model, one or more pixel values associated with a digital frame of the plurality of digital frames, the one or more pixel values corresponding to the intent;
transforming, by the computing device, the one or more respective original pixel values associated with the digital frame based on the one or more pixel values associated with the digital frame;
obtaining, by the computing device and in response to transforming the one or more respective original pixel values of the digital frame, relationships between respective digital frames in the plurality of digital frames based on respective displacements of attributes associated with the respective digital frames, the respective displacements of the attributes occurring between sequential digital frames in the plurality of digital frames;
obtaining, by the computing device, one or more pixel values associated with at least one digital frame of the plurality of digital frames based on one or more corresponding pixel values associated with other digital frames of the plurality of digital frames and the relationships between the respective digital frames in the plurality of digital frames; and
transforming, by the computing device, one or more original pixel values associated with the at least one digital frame based on the one or more pixel values associated with the at least one digital frame.

19. The method of claim 18, wherein transforming the one or more respective original pixel values associated with the digital frame comprises:
determining the intent is associated with replacing the one or more respective original pixel values to remove at least one attribute associated with the digital frame from the digital frame;
removing the one or more respective original pixel values associated with the digital frame; and
replacing the one or more respective original pixel values associated with the digital frame with the one or more pixel values associated with the digital frame.

20. The method of claim 18, wherein transforming the one or more respective original pixel values associated with the digital frame comprises:
determining the intent is associated with updating the one or more respective original pixel values to add a new attribute associated with the digital frame or to modify an existing attribute associated with the digital frame; and
updating the one or more respective original pixel values associated with the digital frame based on the one or more pixel values associated with the digital frame.
